(19) United States
(12) Patent Application Publication
(10) Pub. No.: US 2010/0012092 A1
(43) Pub. Date: Jan. 21, 2010

(54) FUEL INJECTION CONTROL DEVICE AND METHOD OF CONTROLLING FUEL INJECTION FOR AN INTERNAL COMBUSTION ENGINE

(76) Inventors: Yoshinori Futonagane, Shizuoka-ken (JP); Fumihiro Okumura, Shizuoka-ken (JP); Shigeo Nomura, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/444,169

(22) PCT Filed: Apr. 9, 2008
(86) PCT No.: PCT/IB2008/000867

§ 371 Date: Apr. 3, 2009

(30) Foreign Application Priority Data
Apr. 10, 2007 (JP) 2007-102341

(51) Int. Cl. F02M 69/54; F02M 47/00

(52) U.S. Cl. 123/457; 239/533.3

(57) ABSTRACT

An outer needle valve (42) and an inner needle valve (43) face on back sides thereof an outer control chamber (R2) and an inner control chamber (R3), which are independent of each other, respectively. An outer fuel outflow passage (C4) and an inner fuel outflow passage (C5) for causing fuel to flow out from the outer control chamber (R2) and the inner control chamber (R3) respectively meet at a meeting portion (Y). A control valve (45) for rendering in communication/shutting off a fuel discharge passage (C6) for connecting the meeting portion (Y) to a fuel tank (T) is interposed in the fuel discharge passage (C6). An automatic valve (44) as an open/close valve for shutting off the outer fuel outflow passage (C4) when a rail pressure (Pcr) is equal to or lower than a predetermined value and rendering in communication the outer fuel outflow passage (C4) when the rail pressure (Pcr) is higher than the predetermined value is interposed in the outer fuel outflow passage (C4).

### BACKGROUND OF THE INVENTION

1. Field of the Invention

The invention relates to a fuel injection control device for an internal combustion engine and a method of controlling fuel injection for the internal combustion engine.

2. Description of the Related Art

Conventionally, as shown in FIG. 28, there has been known a so-called twin needle type fuel injection control device (e.g., see Japanese Patent Application Publication No. 2006-152893 (JP-A-2006-152893) and Japanese Patent Application Publication No. 2006-307832 (JP-A-2006-307832)) that is equipped with a body 110, an outer needle valve 120, an inner needle valve 130, a nozzle chamber 140, a control chamber 150, a fuel supply passage 160, a fuel inflow passage 170, a fuel discharge passage 180, and a control valve 190. The body 110 is equipped at a tip thereof, which faces a combustion chamber of an internal combustion engine (especially a diesel engine), with first injection holes (first injection hole group) 111 and second injection holes (second injection hole group) 112 located closer to the tip side of the body 110 (on the lower side in FIG. 28) than the first injection holes 111. The outer needle valve 120 is slidably accommodated in the body 110 to open/close the first injection holes 111 on a tip side of the outer needle valve 120 (on the lower side in FIG. 28), and assumes a tubular shape. The inner needle valve 130 is slidably accommodated inside the outer needle valve 120 to open/close the second injection holes 112 on a tip side of the inner needle valve 130 (on the lower side in FIG. 28), and assumes a rod-like shape. The nozzle chamber 140 is provided on the tip sides of the outer needle valve 120 and the inner needle valve 130, and is designed such that each of the outer needle valve 120 and the inner needle valve 130 receives on the tip side thereof a force acting in a valve opening direction due to a rail pressure Pcr as a pressure of fuel inside the nozzle chamber 140, and that fuel inside the nozzle chamber 140 is injected toward the combustion chamber via the first injection holes 111 and the second injection holes 112 with the outer needle valve 120 and the inner needle valve 130 in their open valve states respectively. The control chamber 150 is provided on back sides of the outer needle valve 120 and the inner needle valve 130 (on the upper side in FIG. 28), and is designed such that each of the outer needle valve 120 and the inner needle valve 130 receives on the back side thereof a force acting in a valve closing direction due to a control pressure Pc as a pressure of fuel inside the control chamber 150. The fuel supply passage 160 connects a high pressure generating portion for generating the rail pressure Pcr of fuel (a hydraulic pump (not shown) and a common rail (not shown)) to the nozzle chamber 140. The fuel inflow passage 170 connects the fuel supply passage 160 to the control chamber 150. The fuel discharge passage 180 connects the control chamber 150 to a fuel tank (not shown). The control valve 190 is interposed in the fuel discharge passage 180 to render in communication/shut off the fuel discharge passage 180.

In the twin needle type fuel injection control device shown in FIG. 28, the control valve 190 is opened (changed from its closed state to its open state) in opening the outer needle valve 120 in its closed valve state and the inner needle valve 130 in its closed valve state (changing each of the outer needle valve 120 and the inner needle valve 130 from its closed valve state (lift amount=0) to its open valve state (lift amount >0)). Thus, fuel is discharged from the control chamber 150 through the fuel discharge passage 180, and the control pressure Pc falls from the rail pressure Pcr (at the same time, fuel flows from the fuel supply passage 160 into the control chamber 150 through the fuel inflow passage 170).

In the twin needle type fuel injection control device shown in FIG. 28, the outer needle valve 120 has a smaller ratio of the pressure-receiving area for the control pressure Pc on the back side to the pressure-receiving area for the rail pressure Pcr on the tip side than the inner needle valve 130. Owing to this difference in ratio, “a valve opening pressure for the outer needle valve” (the control pressure Pc at a time point when the outer needle valve 120 makes a transition from its closed valve state to its open valve state) is higher than “a valve opening pressure for the inner needle valve” (the control pressure Pc at a time point when the inner needle valve 130 makes a transition (by itself) from its closed valve state to its open valve state).

Accordingly, when the control pressure Pc, which falls from the rail pressure Pcr as described above, reaches “the valve opening pressure for the outer needle valve”, only the outer needle valve 120 opens (moves upward in FIG. 28) first. As a result, fuel injection is started/carried out only via the first injection holes (first injection hole group) 111.

After that, an upper end face (back face) of the outer needle valve 120 moving upward abuts on a lower face of a flange portion 131 of the inner needle valve 130, and the outer needle valve 120 and the inner needle valve 130 can thereafter ascend only integrally. This integrated body of the outer needle valve 120 and the inner needle valve 130 will be referred to hereinafter as “an integrated needle valve” as well.

Then, when the falling control pressure Pc reaches “a valve opening pressure for the integrated needle valve” (the control pressure Pc at a time point when the inner needle valve 130 as part of the integrated needle valve makes a transition from its closed valve state to its open valve state), the inner needle valve 130 opens (moves upward in FIG. 28) as well. As a result, fuel injection is started/carried out via the second injection holes (second injection hole group) 112 in addition to the first injection holes 111.

On the other hand, the control valve 190 is closed (changed from its open valve state to its closed valve state) in closing the outer needle valve 120 and the inner needle valve 130, which are in their open valve states as described above. Thus, while fuel is stopped from being discharged from the control chamber 150 through the fuel discharge passage 180, the inflow of fuel into the control chamber 150 through the fuel inflow passage 170 is continued. As a result, the control pressure Pc rises toward the rail pressure Pcr, the integrated needle valve descends (moves downward in FIG. 28), and the inner needle valve 130 closes first. Thus, fuel injection from the second injection holes is terminated. Subsequently, the outer needle valve 120 descends independently of the inner needle valve 130 and closes as well. Thus, fuel injection from the first injection holes is terminated as well. In this manner, by controlling the control valve 190 to control the control pressure Pc, the lift amounts of the outer needle valve 120 and the inner needle valve 130 are adjusted in performing injection control of fuel.

In the case where the pressure in the single control chamber (the control pressure Pc) is controlled by a single open/close valve (the control valve 190) to adjust the lift amounts of the outer needle valve 120 and the inner needle valve 130 as in the aforementioned case of the twin needle type fuel injection control device shown in FIG. 28, the outer needle valve opens first and then the inner needle valve opens. Accordingly, as shown in FIG. 29, in the-case of a small injection amount, for example, at the time of low load when the load of the internal combustion engine is small or at the time of pilot injection carried out prior to main injection, only the first injection holes open. In the case of a large injection amount, for example, at the time of intermediate/high load when the load of the internal combustion engine is relatively large, the second injection holes open as well after the first injection holes open.

In consideration of the above, the diameter of the first injection holes and the diameter of the second injection holes are usually set relatively small and relatively large respectively in the twin needle type fuel injection control device shown in FIG, 28. Thus, in the case of a small injection amount, fuel sprays are injected at a large spraying angle from the first injection holes, the atomization of fuel sprays is promoted, and the amount of smoke in exhaust gas can be reduced. In the case of a large injection amount, fuel injection can be carried out at a high injection rate (injection amount per unit time) from the second injection holes, and hence an insufficient injection rate can be sufficiently compensated for (a reduction in total fuel injection period can therefore be achieved).

At the time of low load, the amount of unburned HC (including methane and referred to hereinafter as “THC”) in exhaust gas tends to be large due to a low combustion temperature. Accordingly, at the time of low load, there is a higher demand for a reduction in the discharge amount of THC than for a reduction in the discharge amount of smoke. In order to reduce the discharge amount of THC, it is conceivable to suppress the diffusion of fuel sprays in the combustion chamber. This is because the suppression of the diffusion of fuel sprays leads to an increase in the local equivalent ratio of a region occupied by fuel sprays, a rise in combustion temperature, and consequently a reduction in the discharge amount of THC.

In order to suppress the diffusion of fuel sprays, it is conceivable to inject fuel from the injection holes with the large diameter to reduce the spraying angle of fuel sprays. It is also conceivable to inject fuel from the injection holes on the lower side (on the tip side). This is because, as shown in FIG. 30, the injection of fuel from the injection holes on the lower side (on the tip side) makes it difficult for fuel sprays to get on squish streams generated through the descent of a piston and the diffusion of fuel sprays is suppressed due to the influence of the squish streams.

That is, as indicated by an experimental result shown in FIG. 31, at the time of low load, the discharge amount of THC decreases as the position of the injection holes from which fuel is injected is lowered and as the diameter of the injection holes is increased. Thus, at the time of low load, there is a demand that the inner needle valve be opened first.

On the other hand, at the time of intermediate/high load, the amount of smoke in exhaust gas is large as a result of a high combustion temperature. Accordingly, as described above, there is a high demand for a reduction in the discharge amount of smoke. In order to reduce the discharge amount of smoke, it is conceivable to promote the diffusion (i.e., atomization) of fuel sprays in the combustion chamber as described above.

In order to promote the diffusion of fuel sprays, it is conceivable to inject fuel from the injection holes with the small diameter to increase the spraying angle of fuel sprays. It is also conceivable to inject fuel from the injection holes on the upper side. This is because, as shown in FIG. 30, the injection of fuel from the injection holes on the upper side makes it easy for fuel sprays to get on the squish streams generated through the descent of the piston and the diffusion of fuel sprays is promoted due to the influence of the squish streams. That is, as indicated by the experimental result shown in FIG. 31, at the time of intermediate/high load, the discharge amount of smoke decreases as the position of the injection holes from which fuel is injected is raised and as the diameter of the injection holes is reduced. Thus, at the time of intermediate/high load, there is a demand that the outer needle valve be opened first to carry out fuel injection mainly through the injection holes on the upper side (the first injection holes 111), as in the case of the fuel injection control device shown in FIG. 28.

Furthermore, around the time of maximum load when the amount of injection is very large, the discharge amount of smoke in exhaust gas is large as a result of a very high combustion temperature, and besides, the discharge amount of THC is large because fuel is injected at a timing when the temperature inside a cylinder becomes low toward the end of a fuel injection period as a result of a long total length thereof. Accordingly, there is a demand for a reduction in the total fuel injection period (i.e., for the ensuring of a high injection rate) as well as a demand for a reduction in the discharge amount of smoke. Thus, around the time of maximum load, there is also a demand that the outer needle valve and the inner needle valve be opened/closed simultaneously.

As described above, the required pattern of fuel injection differs depending on the operational range of the internal combustion engine. Therefore, in order to meet those demands sufficiently, it is necessary to ensure a degree of freedom in the pattern of fuel injection corresponding to the operational range. However, as described above, in the case of the twin needle type fuel injection control device shown in FIG. 28 which is designed such that the outer needle valve and the inner needle valve are opened in this order without fail (i.e., the device designed such that the pressure in the single control chamber is controlled by the single open/close valve to adjust the lift amounts of the outer needle valve and the inner needle valve), there is a problem in that the degree of freedom in the pattern of fuel injection cannot be ensured.

In order to cope with this problem, it is conceivable to provide the outer needle valve and the inner needle valve with control chambers (hydraulic chambers on the back sides of the needle valves) independently (i.e., an outer control chamber+an inner control chamber), and to provide open/close valves for controlling the pressures in the outer control chamber and the inner control chamber independently as well.

In general, however, such open/close valves (control valves) are constructed using electromagnets, piezoelectric elements, or the like and hence are relatively large in size. Accordingly, if the aforementioned construction requiring two control valves is adopted, there arises a new problem, namely, an increase in the size of the entire device.

### SUMMARY OF THE INVENTION

The invention provides a twin needle type fuel injection control device capable of ensuring a degree of freedom in the pattern of fuel injection corresponding to the range of operation with the aid of a single control valve, and a method of controlling fuel injection capable of achieving the same purpose.

The fuel injection control device according to an aspect of the invention is equipped with a body having the first injection holes and the second injection holes, the outer needle valve and the inner needle valve, the nozzle chamber, the outer control chamber and the inner control chamber that are independent of each other, the high pressure generating portion, the fuel supply passage, an outer fuel inflow passage connecting the fuel supply passage to the outer control chamber, an inner fuel inflow passage connecting the fuel supply passage to the inner control chamber, an outer fuel outflow passage connected at an upstream end thereof to the outer control chamber, an inner fuel outflow passage connected at an upstream end thereof to the inner control chamber and meeting at a downstream end thereof with a downstream end of the outer fuel outflow passage, a fuel discharge passage connecting a meeting portion of the outer fuel outflow passage and the inner fuel outflow passage to a fuel tank, a (single) control valve interposed in the fuel discharge passage to render in communication/shut off the fuel discharge passage, and an automatic valve interposed in at least one of the outer fuel inflow passage and the inner fuel inflow passage or at least one of the outer fuel outflow passage and the inner fuel outflow passage to control the flow of fuel in accordance with the rail pressure.

In this construction, the outer fuel inflow passage and the inner fuel inflow passage may be provided with orifices respectively, and the outer fuel outflow passage and the inner fuel outflow passage may be provided with orifices respectively. The diameter of the first injection holes (the opening area of each of the holes of the first injection hole group) may be smaller than the diameter of the second injection holes (the opening area of each of the holes of the second injection hole group). The “valve opening pressure for the outer needle valve” may be higher than the “valve opening pressure for the inner needle valve”.

According to this construction, the (single) control valve for rendering in communication/shutting off the fuel discharge passage, which connects the meeting portion of the outer fuel outflow passage and the inner fuel outflow passage to the fuel tank, is interposed in the fuel discharge passage. Accordingly, the pressures in the outer control chamber and the inner control chamber (=an outer control pressure and an inner control pressure) are controlled by performing open/close control of the single control valve.

In this case, due to the operation of the automatic valve, the flow of fuel through the flow passage for causing fuel to flow into the outer control chamber and the inner control chamber or the flow passage for causing fuel to flow out from the outer control chamber and the inner control chamber is controlled in accordance with the rail pressure. Accordingly, the outer control pressure and the inner control pressure can be adjusted independently of each other in accordance with the rail pressure, and the lift amounts of the outer needle valve and the inner needle valve can also be adjusted independently of each other in accordance with the rail pressure.

That is, when the rail pressure changes in accordance with the range of operation (e.g., load, operational speed, and the like) (e.g., when the rail pressure rises with increases in load and with increases in operational speed), the degree of freedom in the pattern of fuel injection corresponding to the range of operation can be ensured using the single control valve. No more control valves are required in addition to the single control valve constructed in a relatively large size using the electromagnet, the piezoelectric element, or the like. Therefore, the entire device can be made small in size with a simple construction.

In the foregoing first aspect of the invention, the automatic valve is interposed in the outer fuel outflow passage, and is designed to shut off the outer fuel outflow passage when the rail pressure is equal to or lower than a first predetermined value and render in communication the outer fuel outflow passage when the rail pressure is higher than the first predetermined value.

According to this construction, when the rail pressure is equal to or lower than the first predetermined value (e.g., at the time of low load), the outer fuel outflow passage is shut off. Therefore, the outer control pressure is held at the rail pressure, and the outer needle valve does not open. Accordingly, only the inner needle valve opens (i.e., only the second injection holes with the large diameter open). That is, only the inner needle valve opens in carrying out pilot injection at the time of low load as well. Therefore, at the time of low load (in carrying out pilot injection at the time of low load as well), the diffusion of fuel sprays in the combustion chamber can be suppressed, and the discharge amount of THC can be reduced.

On the other hand, when the rail pressure is higher than the first predetermined value (e.g., at the time of intermediate/high load), the outer needle valve and the inner needle valve open in this order (i.e., the first injection holes with the small diameter and the second injection holes with the large diameter open in this order), as in the case of the aforementioned device shown in FIG. 28. That is, only the outer needle valve opens in carrying out pilot injection at the time of intermediate/high load. Accordingly, at the time of intermediate/high load (in carrying out pilot injection at the time of intermediate/high load as well), the diffusion (i.e., atomization) of fuel sprays in the combustion chamber is promoted, and the discharge amount of smoke can be reduced.

In a second aspect of the invention, the automatic valve is interposed in the outer fuel outflow passage, and is designed to shut off the outer fuel outflow passage when a differential pressure between the rail pressure and the inner control pressure is equal to or lower than a predetermined value and render in communication the outer fuel outflow passage when the differential pressure is higher than the predetermined value.

According to this construction, the outer control pressure starts falling as soon as the inner control pressure falls from the rail pressure by the differential pressure due to the opening of the control valve. Accordingly, in the case of a small injection amount (i.e., when the open valve period of the control valve is short), the control valve is closed before the outer control pressure falls to the aforementioned “valve opening pressure for the outer needle valve”. As a result, the outer needle valve does not open. That is, in the case of a small injection amount (e.g., at the time of pilot injection, low load, or the like), only the inner needle valve can be opened (i.e., only the second injection holes with the large diameter can be opened), as in the case of the foregoing first aspect of the invention.

On the other hand, in the case of a large injection amount (i.e., when the open valve period of the control valve is long), the outer control pressure can fall to the aforementioned “valve opening pressure for the outer needle valve”. However, due to the aforementioned operation of the automatic valve, the timing when the outer control pressure starts falling is retarded, and the timing for opening the outer needle valve is therefore retarded as well. As a result, in the case of a large injection amount (in general, at the time of intermediate/high load), the inner needle valve and the outer needle valve can be opened in this order (i.e., the second injection holes with the large diameter and the first injection holes with the small diameter can be opened in this order), as opposed to the case of the foregoing first aspect of the invention. That is, the pattern of injection at the time of intermediate/high load can be set different from the pattern in the foregoing first aspect of the invention.

In a third aspect of the invention, a first fuel outflow passage fitted with a first orifice allowing the passage of fuel flowing out from the outer fuel outflow passage or the inner fuel outflow passage, and a second fuel outflow passage fitted with a second orifice allowing the passage of fuel flowing out from the outer fuel outflow passage or the inner fuel outflow passage and meeting at a downstream end thereof with a downstream end of the first fuel outflow passage are provided. The second orifice has a throttle portion that is larger in opening area than a throttle portion of the first orifice. The automatic valve is connected to downstream ends of the outer fuel outflow passage and the inner fuel outflow passage and upstream ends of the first fuel outflow passage and the second fuel outflow passage, and is designed to connect the outer fuel outflow passage to the first fuel outflow passage and the inner fuel outflow passage to the second fuel outflow passage when the rail pressure is equal to or lower than a first predetermined value, and connect the outer fuel outflow passage to the second fuel outflow passage and the inner fuel outflow passage to the first fuel outflow passage when the rail pressure is higher than the first predetermined value. The (single) control valve is interposed in a fuel discharge passage connecting the meeting portion of the first fuel outflow passage and the second fuel outflow passage to the fuel tank, and is designed to render in communication/shut off the fuel discharge passage.

According to this construction, when the rail pressure is equal to or lower than the first predetermined value (e.g., at the time of low load), fuel in the outer control chamber and fuel in the inner control chamber are discharged to the fuel tank via the first orifice with a small throttle diameter and the second orifice with a large throttle diameter respectively with the control valve in its open valve state. Accordingly, the inner control pressure falls faster than the outer control pressure. As a result, the inner control pressure reaches the “valve opening pressure for the inner needle valve” earlier than the outer control pressure reaches the “valve opening pressure for the outer needle valve”. That is, the inner needle valve and the outer needle valve open in this order (i.e., the second injection holes with the large diameter and the first injection holes with the small diameter open in this order). That is, only the inner needle valve opens in carrying out pilot injection at the time of low load. Therefore, at the time of low load (in carrying out pilot injection at the time of low load as well), the diffusion of fuel sprays in the combustion chamber can be suppressed, and the discharge amount of THC can be reduced.

On the other hand, when the rail pressure is higher than the first predetermined value (e.g., at the time of intermediate/high load), fuel in the outer control chamber and fuel in the inner control chamber are discharged to the fuel tank via the second orifice with the large throttle diameter and the first orifice with the small throttle diameter respectively with the control valve in its open valve state. That is, as opposed to the aforementioned case, the outer control pressure falls faster than the inner control pressure. As a result, the outer needle valve and the inner needle valve open in this order (i.e., the first injection holes with the small diameter and the second injection holes with the large diameter open in this order). That is, in carrying out pilot injection at the time of intermediate/high load, only the outer needle valve opens. Accordingly, at the time of intermediate/high load (in carrying out pilot injection at the time of intermediate/high load as well), the diffusion (i.e., atomization) of fuel sprays in the combustion chamber is promoted, and the discharge amount of smoke can be reduced.

In a fourth aspect of the invention, the inner fuel inflow passage has a first inner fuel inflow passage and a second inner fuel inflow passage, and the automatic valve is interposed in the second inner fuel inflow passage and is designed to shut off the second inner fuel inflow passage when the rail pressure is equal to or lower than the first predetermined value and render in communication the second inner fuel inflow passage when the rail pressure is higher than the first predetermined value.

According to this construction, when the rail pressure is equal to or lower than the first predetermined value (e.g., at the time of low load), fuel flows from the fuel supply passage into the inner control chamber only via the first inner fuel inflow passage with the control valve in its open valve state. When the rail pressure is higher than the first predetermined value (e.g., at the time of intermediate/high load), fuel flows from the fuel supply passage into the inner control chamber via the first inner fuel inflow passage and the second inner fuel inflow passage. On the other hand, fuel flows from the fuel supply passage into the outer control chamber only via the outer fuel inflow passage without depending on the rail pressure.

As is apparent from the foregoing description, when the rail pressure is equal to or lower than the first predetermined value, the inner control pressure can be made to fall faster than the outer control pressure. As a result, as in the case of the foregoing third aspect of the invention, the inner needle valve and the outer needle valve open in this order (i.e., the second injection holes with the large diameter and the first injection holes with the small diameter open in this order). Therefore, at the time of low load (in carrying out pilot injection at the time of low load as well), the diffusion of fuel sprays in the combustion chamber can be suppressed, and the discharge amount of THC can be reduced.

On the other hand, when the rail pressure is higher than the first predetermined value, the outer control pressure can be made to fall faster than the inner control pressure. As a result, as in the case of the foregoing third aspect of the invention, the outer needle valve and the inner needle valve open in this order (i.e., the first injection holes with the small diameter and the second injection holes with the large diameter open in this order). Therefore, at the time of intermediate/high load (in carrying out pilot injection at the time of intermediate/high load as well), the diffusion (i.e., atomization) of fuel sprays in the combustion chamber is promoted, and the discharge amount of smoke can be reduced.

In a modification example of the fourth aspect of the invention, the outer fuel inflow passage has a first outer fuel inflow passage and a second outer fuel inflow passage, and the automatic valve is interposed in the second outer fuel inflow passage and is designed to render in communication the second outer fuel inflow passage when the rail pressure is equal to or lower than the first predetermined value and shut off the second outer fuel inflow passage when the rail pressure is higher than the first predetermined value.

According to this construction, when the rail pressure is equal to or lower than the first predetermined value (e.g., at the time of low load), fuel flows from the fuel supply passage into the outer control chamber via the first outer fuel inflow passage and the second outer fuel inflow passage with the control valve in its open valve state. When the rail pressure is higher than the first predetermined value (e.g., at the time of intermediate/high load), fuel flows from the fuel supply passage into the outer control chamber only via the first outer fuel inflow passage. On the other hand, fuel flows from the fuel supply passage into the inner control chamber only via the inner fuel inflow passage without depending on the rail pressure.

As is apparent from the foregoing description, as in the case of the foregoing fourth aspect of the invention, the inner control pressure can be made to fall faster than the outer control pressure when the rail pressure is equal to or lower than the first predetermined value, and the outer control pressure can be made to fall faster than the inner control pressure when the rail pressure is higher than the first predetermined value. Accordingly, an operation and an effect identical to those of the foregoing fourth aspect of the invention can be achieved.

In a fifth aspect of the invention, a second outer fuel inflow passage connecting the fuel supply passage to the outer control chamber, and a second automatic valve interposed in the second fuel inflow passage to shut off the second outer fuel inflow passage when the rail pressure is equal to or lower than a second predetermined value larger than the first predetermined value and render in communication the second outer fuel inflow passage when the rail pressure is higher than the second predetermined value are further provided. The second outer fuel inflow passage is different from the outer fuel inflow passage.

According to this construction, in the case where the rail pressure is higher than the first predetermined value (e.g., at the time of intermediate/high load), especially only when the rail pressure is higher than the second predetermined value (> the first predetermined value) (e.g., around the time of maximum load), an operation and an effect different from those of the foregoing first aspect of the invention are achieved.

That is, when the rail pressure is higher than the second predetermined value, fuel flows from the fuel supply passage into the outer control chamber via the second outer fuel inflow passage as well as the outer fuel inflow passage during the opening of the control valve or after the closing of the control valve. That is, in comparison with the foregoing first aspect of the invention, the outer control pressure can be made to fall slower during the opening of the control valve, and to increase faster after the closing of the control valve. In other words, in comparison with the foregoing first aspect of the invention, the timing for opening the outer needle valve can be retarded, and the timing for closing the outer needle valve can be advanced.

Accordingly, the outer needle valve and the inner needle valve can be opened/closed substantially simultaneously. Therefore, around the time of maximum load, the total period of fuel injection can be shortened (hence a higher injection rate can be ensured) in comparison with the foregoing first aspect of the invention.

As is apparent from the foregoing description, a valve constructed using an electromagnet, a piezoelectric element, or the like and controlled with the aid of an electric signal may be adopted as the automatic valve employed in each of the foregoing aspects of the invention. However, this type of valve is large in size as described above. Accordingly, the automatic valve employed in each of the foregoing aspects of the invention may be constructed using a spool that operates upon receiving the pressure of fuel without the aid of an electric signal. According to this construction, the automatic valve can be constructed in a small size. As a result, the entire device can further be reduced in size.

In the foregoing first aspect of the invention, the automatic valve may be equipped with a spool for rendering in communication/shutting off the outer fuel outflow passage, and may be designed such that the spool receives on one end side thereof a force acting in a valve opening direction due to the rail pressure, receives on the other end side thereof a force acting in a valve closing direction due to an urging force of an elastic member, and operates in accordance with the rail pressure without the aid of an electric signal.

In the foregoing second aspect of the invention, the automatic valve may be equipped with a spool for rendering in communication/shutting off the outer fuel outflow passage, and may be designed such that the spool receives on one end side thereof a force acting in a valve opening direction due to the rail pressure, receives on the other end side thereof a force acting in a valve closing direction due to the inner control pressure and an urging force of an elastic member, and operates in accordance with the differential pressure without the aid of an electric signal.

In the foregoing third aspect of the invention, the automatic valve may be equipped with a spool for making a changeover in a relationship about how the outer fuel outflow passage and the inner fuel outflow passage are connected to the first fuel outflow passage and the second fuel outflow passage, and may be designed such that the spool receives on one end side thereof a force resulting from the rail pressure, receives on the other end side thereof an urging force of an elastic member, and operates in accordance with the rail pressure without the aid of an electric signal.

In the foregoing fourth aspect of the invention, the automatic valve may be equipped with a spool for rendering in communication/shutting off the second inner fuel inflow passage, and may be designed such that the spool receives on one end side thereof a force acting in a valve opening direction due to the rail pressure, receives on the other end side thereof a force acting in a valve closing direction due to an urging force of an elastic member, and operates in accordance with the rail pressure without the aid of an electric signal.

In the modification example of the foregoing fourth aspect of the invention, the automatic valve may be equipped with a spool for rendering in communication/shutting up the second outer fuel inflow passage, and may be designed such that the spool receives on one end side thereof a force acting in a valve closing direction due to the rail pressure, receives on the other end side thereof a force acting in a valve opening direction due to an urging force of an elastic member, and operates in accordance with the rail pressure without the aid of an electric signal.

In the foregoing fifth aspect of the invention, the automatic valve may be equipped with a spool for rendering in communication/shutting off the outer fuel outflow passage, and may be designed such that the spool receives on one end side thereof a force acting in a valve opening direction due to the rail pressure, receives on the other end side thereof a force acting in a valve closing direction due to an urging force of an elastic member, and operates in accordance with the rail pressure without an aid of an electric signal, and the second automatic valve may be equipped with a second spool for rendering in, communication/shutting off the second outer fuel inflow passage, and may be designed such that the second spool receives on one end side thereof a force acting in a valve opening direction due to the rail pressure, receives on the other end side thereof a force acting in a valve closing direction due to an urging force of an elastic member, and operates in accordance with the rail pressure without the aid of an electric signal.

A sixth aspect of the invention provides a method for controlling a fuel injection device. The fuel injection device includes a body equipped at a tip portion thereof, which faces a combustion chamber of an internal combustion engine, with a first injection hole and a second injection hole located closer to a tip side of the body than the first injection hole, a tubular outer needle valve slidably accommodated in the body to open/close the first injection hole on a tip side of the outer needle valve, a rod-like inner needle valve slidably accommodated inside the outer needle valve to open/close the second injection hole on a tip side of the inner needle valve, a nozzle chamber provided on the tip sides of the outer needle valve and the inner needle valve and designed such that each of the outer needle valve and the inner needle valve receives on the tip side thereof a force acting in a valve opening direction due to a rail pressure as a pressure of fuel inside the nozzle chamber and that fuel inside the nozzle chamber is injected toward the combustion chamber via the first injection hole and the second injection hole with the outer needle valve and the inner needle valve in their valve open states respectively, an outer control chamber provided on a back side of the outer needle valve and designed such that the outer needle valve receives on the back side thereof a force acting in a valve closing direction due to an outer control pressure as a pressure of fuel inside the outer control chamber, an inner control chamber, which is independent of the outer control chamber, provided on a back side of the inner needle valve and designed such that the inner needle valve receives on the back side thereof a force acting in a valve closing direction due to an inner control pressure as a pressure of fuel inside the inner control chamber, a high pressure generating portion for turning a pressure of fuel into the rail pressure, a fuel supply passage connecting the high pressure generating portion to the nozzle chamber, an outer fuel inflow passage connecting the fuel supply passage to the outer control chamber, an inner fuel inflow passage connecting the fuel supply passage to the inner control chamber, an outer fuel outflow passage connected at an upstream end thereof to the outer control chamber, an inner fuel outflow passage connected at an upstream end thereof to the inner control chamber and meeting at a downstream end thereof with a downstream end of the outer fuel outflow passage, a fuel discharge passage connecting a meeting portion of the outer fuel outflow passage and the inner fuel outflow passage to a fuel tank, a control valve interposed in the fuel discharge passage to render in communication/shut off the fuel discharge passage, and an automatic valve interposed in at least one of the outer fuel inflow passage and the inner fuel inflow passage or at least one of the outer fuel outflow passage and the inner fuel outflow passage to control flow of fuel in accordance with the rail pressure. The method includes controlling the control valve to control the outer control pressure and the inner control pressure so that lift amounts of the outer needle valve and the inner needle valve are adjusted independently of each other in performing injection control of fuel.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic constructional view of an entire fuel injection control device according to a first embodiment of the invention;

FIG. 2 is a graph showing how rail pressure is related to engine rotational speed and load;

FIG. 3 is composed of time charts showing an example of the operation of the first embodiment of the invention at the time of low rail pressure;

FIG. 4 is composed of time charts showing an example of the operation of the first embodiment of the invention at the time of intermediate/high rail pressure;

FIG. 5 is a schematic constructional view of an entire fuel injection control device according to a second embodiment of the invention;

FIG. 6 is composed of time charts showing an example of the operation of the second embodiment of the invention in the case of a small injection amount;

FIG. 7 is composed of time charts showing an example of the operation of the second embodiment of the invention in the case of a large injection amount;

FIG. 8 is a schematic constructional view of an entire fuel injection control device according to a modification example of the second embodiment of the invention;

FIG. 9 is composed of time charts showing an example of the operation of the modification example of the second embodiment of the invention in the case of a small injection amount;

FIG. 10 is composed of time charts showing an example of the operation of the modification example of the second embodiment of the invention in the case of a large injection amount;

FIG. 11 is a schematic constructional view of an entire fuel injection control device according to a third embodiment of the invention;

FIG. 12 is composed of time charts showing an example of the operation of the third embodiment of the invention at the time of low rail pressure;

FIG. 13 is composed of time charts showing an example of the operation of the third embodiment of the invention at the time of intermediate/high rail pressure;

FIG. 14 is a schematic constructional view of an entire fuel injection control device according to a fourth embodiment of the invention;

FIG. 15 is composed of time charts showing an example of the operation of the fourth embodiment of the invention at the time of low rail pressure;

FIG. 16 is composed of time charts showing an example of the operation of the fourth embodiment of the invention at the time of intermediate/high rail pressure;

FIG. 17 is a schematic constructional view of an entire fuel injection control device according to a modification example of the fourth embodiment of the invention;

FIG. 18 is a schematic constructional view of an entire fuel injection control device according to a fifth embodiment of the invention;

FIG. 19 is composed of time charts showing an example of the operation of the fifth embodiment of the invention at the time of low rail pressure;

FIG. 20 is composed of time charts showing an example of the operation of the fifth embodiment of the invention at the time of intermediate rail pressure;

FIG. 21 is composed of time charts showing an example of the operation of the fifth embodiment of the invention at the time of high rail pressure;

FIG. 22 is a graph showing how the pattern of fuel injection is related to load and engine rotational speed;

FIG. 23 is a main cross-sectional view of an automatic valve according to the first embodiment of the invention in its shut-off state;

FIG. 24 is a main cross-sectional view of an automatic valve according to the first embodiment of the invention in its communicating state;

FIG. 25 is a main cross-sectional view of an automatic valve according to the modification example of the first embodiment of the invention in its shut-off state;

FIG. 26 is a main cross-sectional view of an automatic valve according to the second embodiment of the invention in its shut-off state;

FIG. 27 is a main cross-sectional view of an automatic valve according to the second embodiment of the invention in its communicating state;

FIG. 28 is a schematic constructional view of an entire conventional fuel injection control device;

FIG. 29 is a view showing a pattern of fuel injection according to the fuel injection control device shown in FIG. 28;

FIG. 30 is a view for explaining how the positions of injection holes are related to the degree of diffusion of fuel sprays resulting from squish streams; and

FIG. 31 is a graph showing an experimental result representing how the amount of THC and the amount of smoke are related to the positions of the injection holes and the diameters of the injection holes.

### DETAILED DESCRIPTION OF EMBODIMENTS

Each embodiment of a fuel injection control device for an internal combustion engine according to the invention will be described hereinafter with reference to the drawings.

### First Embodiment

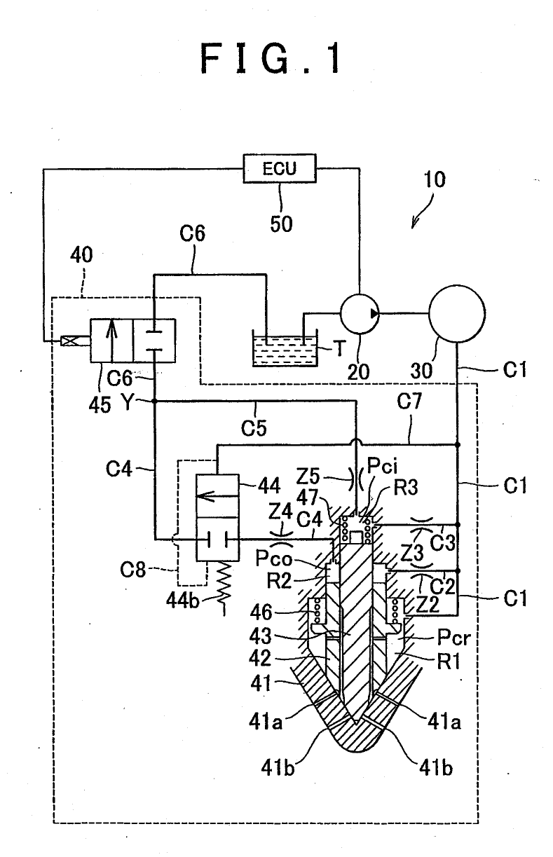

FIG. 1 shows a schematic construction of an entire fuel injection control device 10 for an internal combustion engine (diesel engine) according to the first embodiment of the invention. This fuel injection control device 10 is equipped with a fuel pump 20 for sucking/discharging fuel stored in a fuel tank T, a common rail 30 supplied with fuel discharged by the fuel pump 20 at a high pressure (hereinafter referred to as “a rail pressure Pcr”), an injector 40 supplied with fuel at the rail pressure Pcr from the common rail 30 through a fuel supply passage C1 to inject fuel into a combustion chamber (not shown) of the internal combustion engine, and an ECU 50 for controlling the fuel pump 20 and the injector 40. The fuel pump 20 and the common rail 30 correspond to the “high pressure generating portion”.

In FIG. 1, the single injector 40 supplied with fuel at the rail pressure Pcr from the common rail 30 through the single fuel supply passage C1 is shown. In fact, however, injectors 40 and fuel supply passages C1 are provided respectively for a plurality of combustion chambers of the internal combustion engine, and each of the injectors 40 is individually connected to the common rail 30 through a corresponding one of the fuel supply passages C1. In the following description, for convenience of explanation, an upper part and a lower part of a sheet of each of the drawings may be simply referred to as “upper” and “lower” respectively.

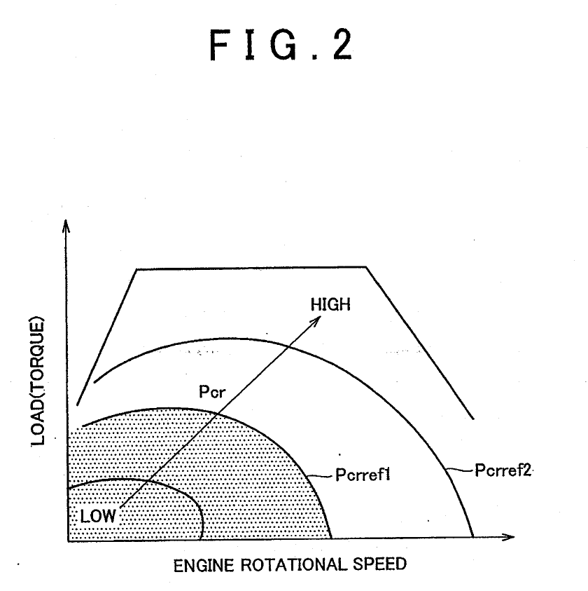

The fuel pump 20 is designed such that the flow rate of fuel sucked thereinto can be adjusted through a command from the ECU 50. Thus, the rail pressure Pcr can be adjusted. More specifically, as shown in FIG. 2, the rail pressure Pcr is adjusted to a value that becomes higher as the load (torque) of the internal combustion engine increases and as the rotational speed of the engine increases.

The injector 40 is mainly equipped with a cylindrical outer needle valve 42 accommodated in a predetermined space inside the body 41 slidably in an axial direction thereof (vertical direction), a columnar inner needle valve 43 coaxially and liquid-tightly accommodated inside the outer needle valve 42 slidably in an axial direction thereof (vertical direction) with respect to the outer needle valve 42, an automatic valve 44 as an open/close valve disposed in the body 41, and a control valve 45 as an open/close valve disposed in the body 41.

The outer needle valve 42 and the inner needle valve 43 liquid-tightly divide the aforementioned predetermined space into a nozzle chamber R1, an outer control chamber R2, and an inner control chamber R3. The nozzle chamber R1 is provided on tip sides (lower end sides) of the outer needle valve 42 and the inner needle valve 43. The outer control chamber R2 and the inner control chamber R3, which are independent of each other, are provided on back sides (upper end sides) of the outer needle valve 42 and the inner needle valve 43 respectively.

The nozzle chamber R1 communicates with the fuel supply passage C1, and the pressure of fuel in the nozzle chamber R1 is equal to the aforementioned rail pressure Pcr. The nozzle chamber R1 communicates with a plurality of first injection holes (first injection hole group) 41a provided at a tip portion of the body 41 in such a manner as to face the combustion chamber, and a plurality of second injection holes (second injection hole group) 41b located closer to the tip side (lower side) of the body 41 than the first injection holes 41a. The diameter of each of the first injection holes 41a is smaller than the diameter of each of the second injection holes 41b.

A conical outer taper portion and a conical inner taper portion, whose diameters decrease toward tips of the outer needle valve 42 and the inner needle valve 43 respectively, are formed at tip portions (lower end portions) of the outer needle valve 42 and the inner needle valve 43 respectively. In a state (a state shown in FIG. 1) where the outer needle valve 42 (the inner needle valve 43) has descended in the aforementioned predetermined space so that the outer taper portion (the inner taper portion) abuts on an inner face (valve seat face) at the tip portion of the body 41 that faces the nozzle chamber R1, the first injection holes 41a (the second injection holes 41b) are shut off from the nozzle chamber R1. In this state, no fuel is injected via the first injection holes 41a (the second injection holes 41b).

This state will be referred to hereinafter as a closed valve state of the outer needle valve 42 (the inner needle valve 43) as well. An outer needle valve lift amount (an inner needle valve lift amount) as a lift amount of the outer needle valve 42 (the inner needle valve 43) means an amount of upward movement (amount of ascent) of the outer needle valve 42 (the inner needle valve 43) from this state. That is, the outer needle valve lift amount (the inner needle valve lift amount) is “0” with the outer needle valve 42 (the inner needle valve 43) in its closed valve state as shown in FIG. 1.

On the other hand, when the outer needle valve 42 (the inner needle valve 43) moves upward (ascends) from its closed valve state and the outer taper portion (the inner taper portion) moves away from the valve seat face, the first injection holes 41a (the second injection holes 41b) communicate with the nozzle chamber R1. In this state (i.e., the outer needle valve lift amount (the inner needle valve lift amount)>0), fuel is injected via the first injection holes 41a (the second injection holes 41b). This state will be referred to hereinafter as an open valve state of the outer needle valve 42 (the inner needle valve 43) as well. In the following description, a transition from the open valve state to the closed valve state will be referred to as “valve closing”, and a transition from the closed valve state to the open valve state will be referred to as “valve opening”.

Each of the outer needle valve 42 and the inner needle valve 43 receives on the lower end side thereof a pressure in the nozzle chamber R1 (=the aforementioned rail pressure Pcr), which is applied to a corresponding predetermined pressure-receiving area of each of the outer needle valve 42 and the inner needle valve 43, and hence a force acting in a valve opening direction (upward). On the other hand, each of the outer needle valve 42 and the inner needle valve 43 receives on the upper end side thereof a pressure in the outer control chamber R2 (=the outer control pressure Pco) and a pressure in the inner control chamber R3 (=the inner control pressure Pci), which are applied to a corresponding predetermined pressure-receiving area of each of the outer needle valve 42 and the inner needle valve 43, and hence a force acting in a valve closing direction (downward).

In addition, coil springs 46 and 47 for constantly urging the outer needle valve 42 and the inner needle valve 43 in the valve closing direction are disposed in the nozzle chamber R1 and the inner control chamber R3 respectively. The coil springs 46 and 47 are provided to prevent the occurrence of, for example, a situation where fuel flows out to the combustion chamber due to the opening of the outer needle valve 42 and the inner needle valve 43 in the case where, for example, the rail pressure Pcr is low during stoppage of the operation of the fuel pump 20 or the like.

As will be described later, the outer control pressure Pco and the inner control pressure Pci can change through the open/close control of the control valve 45. When this outer control pressure Pco (the inner control pressure Pci) is reduced to a certain pressure lower than the rail pressure Pcr (a valve opening pressure for the outer needle valve (a valve opening pressure for the inner needle valve)), the outer needle valve 42 (the inner needle valve 43) opens.

In the first embodiment of the invention, a ratio of the aforementioned pressure-receiving area of the outer control pressure Pco on the upper end side of the outer needle valve 42 to the aforementioned pressure-receiving area for the rail pressure Pcr on the lower end side of the outer needle valve 42 is smaller than a ratio of the aforementioned pressure-receiving area of the inner control pressure Pci on the upper end side of the inner needle valve 43 to the aforementioned pressure-receiving area on the lower end side of the inner needle valve 43. Thus, “the valve opening pressure for the outer needle valve” (the outer control pressure Pco at a time point when the outer needle valve 42 makes a transition from its closed valve state to its open valve state) is higher than “the valve opening pressure for the inner needle valve” (the inner control pressure Pci at a time point when the inner needle valve 43 makes a transition from its closed valve state to its open valve state).

The outer control chamber R2 (the inner control chamber R3) is connected to the fuel supply passage C1 via an outer fuel inflow passage C2 (an inner fuel inflow passage C3) fitted with an outer inflow orifice Z2 (an inner inflow orifice Z3). Thus, fuel flows from the fuel supply passage C1 into the outer control chamber R2 (the inner control chamber R3) through the outer fuel inflow passage C2 (the inner fuel inflow passage C3) in accordance with a differential pressure between the rail pressure Pcr and the outer control pressure Pco (the inner control pressure Pci). In the first embodiment of the invention, the outer inflow orifice Z2 has a smaller throttle diameter than the inner inflow orifice Z3.

The outer control chamber R2 (the inner control chamber R3) is connected to an upstream end of an outer fuel outflow passage C4 (an inner fuel outflow passage C5) fitted with an outer outflow orifice Z4 (an inner outflow orifice Z5). The outer fuel outflow passage C4 is further fitted with an automatic valve 44 capable of opening/closing the outer fuel outflow passage C4. In the first embodiment of the invention, the outer outflow orifice Z4 has the same throttle diameter as the inner outflow orifice Z5.

Downstream ends of the outer fuel outflow passage C4 and the inner fuel outflow passage C5 meet with each other at a meeting portion Y, and the meeting portion Y is connected to the fuel tank T via a fuel discharge passage C6. The fuel discharge passage C6 is fitted with a control valve 45 capable of opening/closing the fuel discharge passage C6.

Thus, when both the automatic valve 44 and the control valve 45 are in their open valve states, the outer control chamber R2 communicates with the fuel tank T, and fuel is discharged from the outer control chamber R2 to the fuel tank T through the outer fuel outflow passage C4 and the fuel discharge passage C6 in accordance with a differential pressure between the outer control pressure Pco and a pressure of fuel in the fuel tank T (=atmospheric pressure). On the other hand, when the automatic valve 44 or the control valve 45 is in its closed valve state, the outer control chamber R2 is shut off from the fuel tank T. Thus, the aforementioned discharge of fuel from the outer control chamber R2 to the fuel tank T is prohibited.

When the control valve 45 is in its open valve state regardless of the open/closed state of the automatic valve 44, the inner control chamber R3 communicates with the fuel tank T, and fuel is discharged from the inner control chamber R3 to the fuel tank T through the inner fuel outflow passage C5 and the fuel discharge passage C6 in accordance with a differential pressure between the inner control pressure Pci and a pressure of fuel in the fuel tank T (=atmospheric pressure). On the other hand, when the control valve 45 is in its closed valve state regardless of the open/closed state of the automatic valve 44, the inner control chamber R3 is shut off from the fuel tank T. Thus, the aforementioned discharge of fuel from the inner control chamber R3 to the fuel tank T is prohibited.

The automatic valve 44 is a two-position, two-port type open/close valve, and is equipped with a spool 44a for opening/closing the outer fuel outflow passage C4 as shown in FIG. 23. The spool 44a receives on an upper face thereof the rail pressure Pcr supplied from the fuel supply passage C1 via a flow passage C7 (see FIG. 1) and hence a force acting downward (in the valve opening direction). On the other hand, the spool 44a receives on a lower face thereof a force acting upward (in the valve closing direction) due to an urging force of a coil spring 44b.

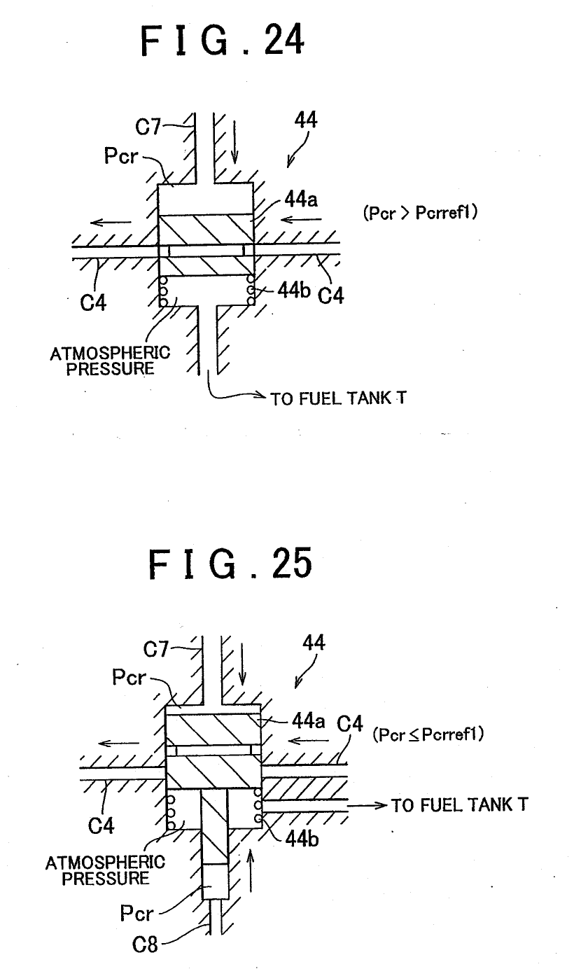

Thus, the spool 44a operates in accordance with the rail pressure Pcr. As a result, the automatic valve 44 shuts off the outer fuel outflow passage C4 (see FIG. 23) when the rail pressure Pcr is equal to or lower than a first predetermined value Pcrref1 (see FIG. 2) (hereinafter referred to also as “at the time of low rail pressure”), and renders in communication the outer fuel outflow passage C4 (see FIG. 24) when the rail pressure Pcr is higher than the first predetermined value Pcrref1 (hereinafter referred to also as “at the time of intermediate/high rail pressure”).

The control valve 45 is a two-position, two-port type electromagnetic open/close valve according to one of known constructions, and can open/close the fuel discharge passage C6 through a command from the ECU 50. As described above, the automatic valve 44 is constructed using the spool valve that operates upon receiving the pressure of fuel without the aid of an electric signal. Therefore, the automatic valve 44 can be constructed in a much smaller size than the control valve 45 as the electromagnetic open/close valve.

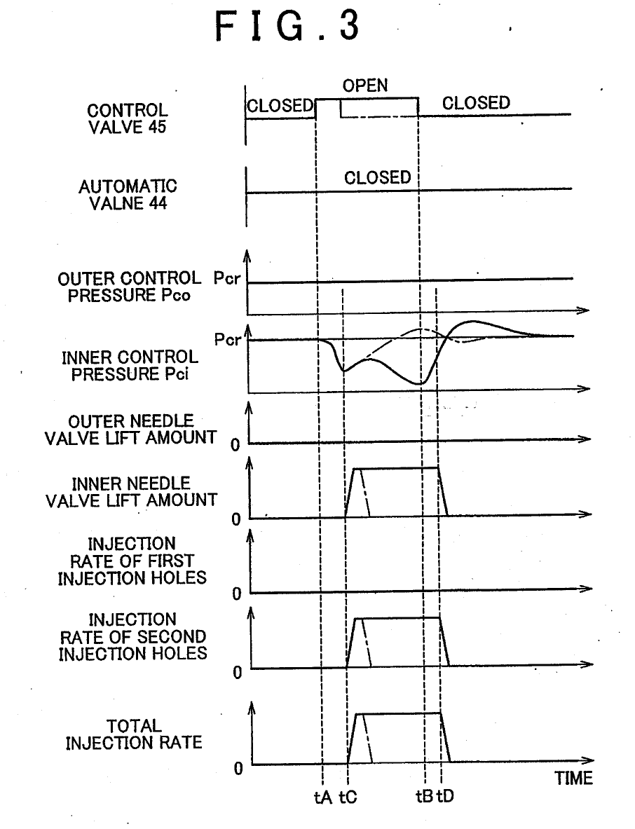

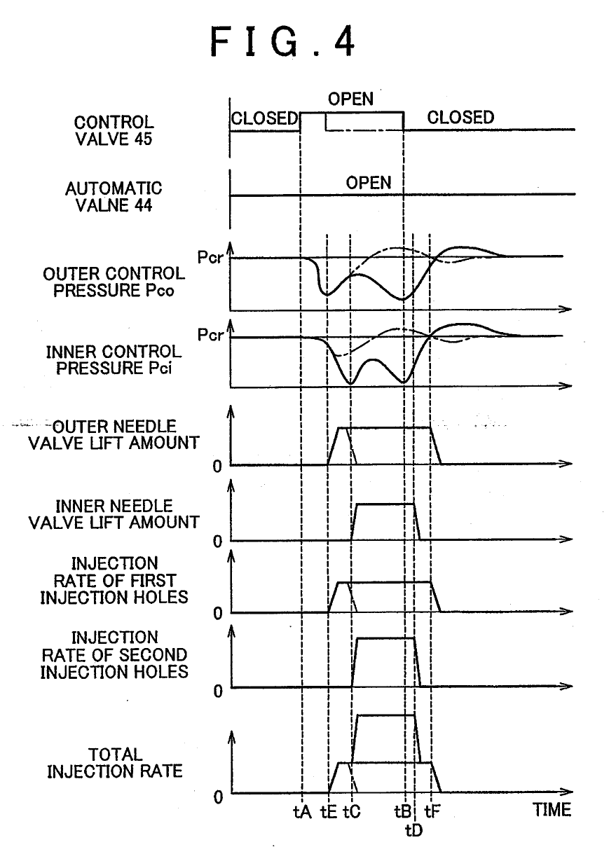

Next, an example of the operation of this fuel injection control device 10 will be described with reference to FIGS. 3 and 4. First of all, FIG. 3 will be described.

Each solid line shown in FIG. 3 indicates an exemplary case where the control valve 45 is held in its open valve state between time points tA and tB at the time of low rail pressure. It is assumed that the rail pressure Pcr is held constant in the example shown in FIG. 3 (as well as the examples shown in the other drawings).

As described above, at the time of low rail pressure, the automatic valve 44 is held in its closed state and hence the outer fuel outflow passage C4 remains shut off. Accordingly, in this case, the outer control pressure Pco is held at the rail pressure Pcr, and the outer needle valve 42 does not open (the outer needle valve lift amount is held at “0”). Accordingly, the injection rate of the first injection holes 41a is held at “0”.

When the control valve 45 opens at the time point tA through a command from the ECU 50, fuel is discharged from the inner control chamber R3 through the inner fuel outflow passage C5 after the time point tA, and the inner control pressure Pci falls from the rail pressure Pcr. In accordance with this fall in the inner control pressure Pci, fuel flows from the fuel supply passage C1 into the inner control chamber R3 through the inner fuel inflow passage C3.

As a result, the inner control pressure Pci falls from the rail pressure Pcr at a speed corresponding to a difference between an outflow flow rate of fuel flowing through the inner outflow orifice Z5 (an inner outflow orifice flow rate Qouti) and an inflow flow rate of fuel flowing through the inner inflow orifice Z3 (an inner inflow orifice flow rate Qini) (=Qouti−Qini).

When the inner control pressure Pci, which falls after the time point tA, reaches the aforementioned “valve opening pressure for the inner needle valve” at a time point tC, the inner needle valve 43 opens (the inner needle valve lift amount starts increasing from “0”). As a result, fuel injection from the second injection holes 41b is started.

After the time point tC, the inner needle valve 43 rises to a position corresponding to a maximum lift amount at a speed corresponding to a speed of decrease in the volume of fuel in the inner control chamber R (=Qouti−Qini), and is thereafter held at the position corresponding to the maximum lift amount. In the meantime, fuel injection from the second injection holes 41b is continued.

After the time point tC, the inner control pressure Pci temporarily increases from “the valve opening pressure for the inner needle valve” as a result of an increase in the pressure-receiving area for the rail pressure Pcr on the lower end side of the inner needle valve 43 and a decrease in the volume of the inner control chamber R3 caused by an increase in the inner needle valve lift amount, and then changes while remaining lower than the rail pressure Pcr.

When the control valve 45 closes through a command from the ECU 50 at the time point tB, the discharge of fuel from the inner control chamber R3 through the inner fuel outflow passage C5 is suspended and the inflow of fuel into the inner control chamber R3 through the inner fuel inflow passage C3 is continued after the time point tB. As a result, the inner control pressure Pci increases toward the rail pressure Pcr after the time point tB, and the inner needle valve 43 descends at a speed corresponding to a speed of increase in the volume of fuel in the inner control chamber R3 (=Qini) after a time point tD somewhat later than the time point tB. Then, when the inner needle valve lift amount becomes “0”, the inner needle valve 43 closes, and fuel injection from the second injection holes 41b is terminated.

As described above, at the time of low rail pressure (hence at the time of low load, see FIG. 2), only the inner needle valve 43 opens, and fuel is injected only from the second injection holes 41b. Accordingly, as indicated by broken lines of FIG. 3, pilot injection with a short valve open period for the control valve 45 is also carried out from the second injection holes 41b at the time of low rail pressure.

It should be noted herein, as described above, that the second injection holes 41b are located on the lower side and have a large diameter. In consequence, as described above, in this first embodiment of the invention, the diffusion of fuel sprays in the combustion chamber can be suppressed and the discharge amount of THC can be reduced at the time of low rail pressure, namely, at the time of low load (in carrying out pilot injection at the time of low load as well).

Next, FIG. 4 will be described. Each solid line shown in FIG. 4 indicates an exemplary case where the control valve 45 is held in its open valve state between the time points tA and tB at the time of intermediate/high rail pressure.

As described above, at the time of intermediate/high rail pressure, the automatic valve 44 is held in its open state, and hence the outer fuel outflow passage C4 remains in communication. Accordingly, in this case, the outer control pressure Pco decreases from the rail pressure Pcr with the automatic valve 44 in its open valve state, and the outer needle valve 42 as well as the inner needle valve 43 opens.

The operation of the outer needle valve 42 will be described hereinafter concretely. When the control valve 45 opens through a command from the ECU 50 at the time point tA, fuel is discharged from the outer control chamber R2 through the outer fuel outflow passage C4 after the time point tA, and the outer control pressure Pco falls from the rail pressure Pcr. In accordance with this fall in the outer control pressure Pco, fuel flows from the fuel supply passage C1 into the outer control chamber R2 through the outer fuel inflow passage C2.

As a result, the outer control pressure Pco falls from the rail pressure Pcr at a speed corresponding to a difference between an outflow flow rate of fuel flowing through the outer outflow orifice Z4 (an outer outflow orifice flow rate Qouto) and an inflow flow rate of fuel flowing through the outer inflow orifice Z2 (an outer inflow orifice flow rate Qino) (=Qouto−Qino).

When the outer control pressure Pco, which falls after the time point tA, reaches the aforementioned “valve opening pressure for the outer needle valve” at a time point tE, the outer needle valve 42 opens (the outer needle valve lift amount starts increasing from “0”). As a result, fuel injection from the first injection holes 41a is started.

After the time point tE, the outer needle valve 42 ascends to a position corresponding to a maximum lift amount at a speed corresponding to a speed of decrease in the volume of fuel in the outer control chamber R2 (=Qouto−Qino), and is thereafter held at the position corresponding to the maximum lift amount. In the meantime, fuel injection from the first injection holes 41a is continued.

After the time point tE, the outer control pressure Pco temporarily increases from “the valve opening pressure for the outer needle valve” as a result of an increase in the pressure-receiving area for the rail pressure Pcr on the lower end side of the outer needle valve 42 and a decrease in the volume of the outer control chamber R2 caused by an increase in the outer needle valve lift amount, and then changes while remaining lower than the rail pressure Pcr.

When the control valve 45 closes through a command from the ECU 50 at the time point tB, the discharge of fuel from the outer control chamber R2 through the outer fuel outflow passage C4 is suspended and the inflow of fuel into the outer control chamber R2 through the outer fuel inflow passage C2 is continued after the time point tB. As a result, the outer control pressure Pco increases toward the rail pressure Pcr after the time point tB, and the outer needle valve 42 descends at a speed corresponding to a speed of increase in the volume of fuel in the outer control chamber R2 (=Qino) after a time point tF somewhat later than the time point tB. Then, when the outer needle valve lift amount becomes “0”, the outer needle valve 42 closes, and fuel injection from the first injection holes 41a is terminated.

On the other hand, as regards the inner needle valve 43, as is the case with the example shown in FIG. 3, the inner needle valve lift amount starts increasing from “0” at the time point tC, and starts decreasing from the maximum lift amount at the time point tD.

It should be noted herein that the time point tE when the outer needle valve lift amount starts increasing from “0” is earlier than the time point tC when the inner needle valve lift amount starts increasing from “0”. This is based on the fact that “the valve opening pressure for the outer needle valve” is higher than “the valve opening pressure for the inner needle valve”. The time point tF when the outer needle valve lift amount starts decreasing from the maximum lift amount is later than the time point tD when the inner needle valve lift amount starts decreasing from the maximum lift amount. This is based on the fact that the throttle diameter of the outer inflow orifice Z2 is smaller than the throttle diameter of the inner inflow orifice Z3.

As described above, at the time of intermediate/high rail pressure (hence at the time of intermediate/high load, see FIG. 2), the outer needle valve 42 and the inner needle valve 43 open in this order, and the inner needle valve 43 and the outer needle valve 42 close in this order. That is, fuel injection is mainly carried out from the first injection holes 41a. Accordingly, as indicated by broken lines of FIG. 4, pilot injection with a short valve open period for the control valve 45 is also carried out from the first injection holes 41a at the time of intermediate/high rail pressure.

It should be noted herein, as described above, that the first injection holes 41a are located on the upper side and have a small diameter. In consequence, as described above, in this first embodiment of the invention, the diffusion (i.e., atomization) of fuel sprays in the combustion chamber is promoted, and the discharge amount of smoke can be reduced at the time of intermediate/high rail pressure, namely, at the time of intermediate/high load (in carrying out pilot injection at the time of intermediate/high load as well).

As described above, according to the first embodiment of the fuel injection control device of the invention, the single control valve 45 as the electromagnetic open/close valve for rendering in communication/shutting off the fuel discharge passage C6, which connects the meeting portion Y of the outer fuel outflow passage C4 and the inner fuel outflow passage C5 to the fuel tank T, is interposed in the fuel discharge passage C6. In addition, the automatic valve 44 for shutting off the outer fuel outflow passage C4 when the rail pressure Pcr is equal to or lower than the first predetermined value Pcrref1 and rendering in communication the outer fuel outflow passage C4 when the rail pressure Pcr is higher than the first predetermined value Pcrref1 is interposed in the outer fuel outflow passage C4.

Owing to the performance of open/close control of this single control valve 45 and the operation of the automatic valve 44, the pressures in the outer control chamber R2 and the inner control chamber R3 (=the outer control pressure Pco and the inner control pressure Pci) are controlled independency of each other, and the pattern of fuel injection from the first injection holes 41a and the second injection holes 41b can be changed in accordance with the rail pressure Pcr. As is apparent from the foregoing description, the degree of freedom in the pattern of fuel injection corresponding to the range of operation can be ensured by controlling the single control valve 45.

In this construction, no more control valves are required in addition to the single control valve 45 that is constructed in a relatively large size using the electromagnet. In addition, the automatic valve 44 is constructed using the spool 44a that operates upon receiving the pressure of fuel without the aid of an electric signal, and hence can be constructed in a much smaller size than the control valve 45. As is apparent from the foregoing description, according to the first embodiment of the invention, the entire device can be made small in size with a simple construction.

### Second Embodiment

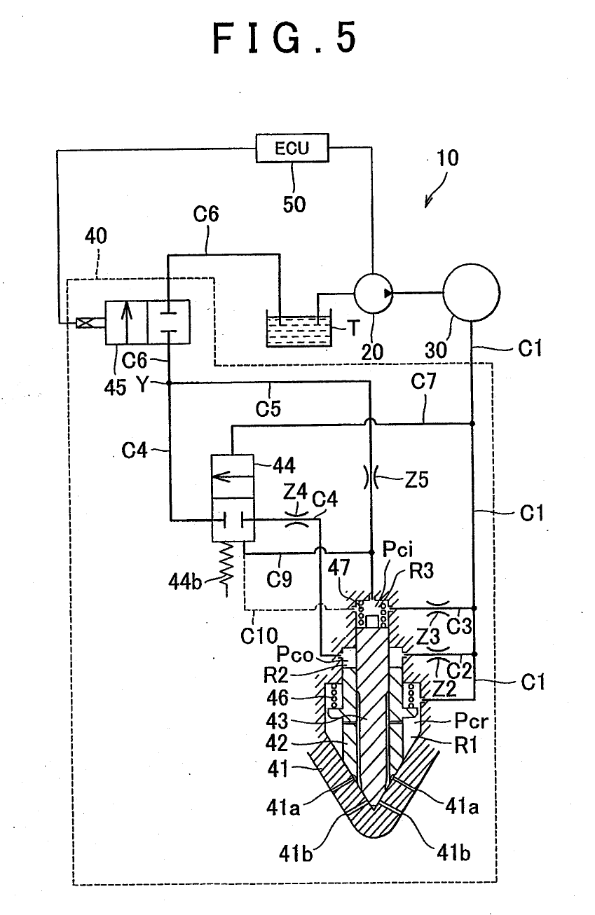

Next, the fuel injection control device 10 for the internal combustion engine according to the second embodiment of the invention will be described. FIG. 5 shows a schematic construction of the entire device according to the second embodiment of the invention. In this second embodiment of the invention (as well as the other embodiments of the invention), constructional details/elements identical to those of the first embodiment of the invention are denoted respectively by the same reference symbols as in the first embodiment of the invention.

This second embodiment of the invention is different from the foregoing first embodiment of the invention in which the automatic valve 44 operates in accordance with the rail pressure Pcr itself, only in that the automatic valve 44 operates in accordance with a differential pressure ΔP (=Pcr−Pci) between the rail pressure Pcr and the inner control pressure Pci.

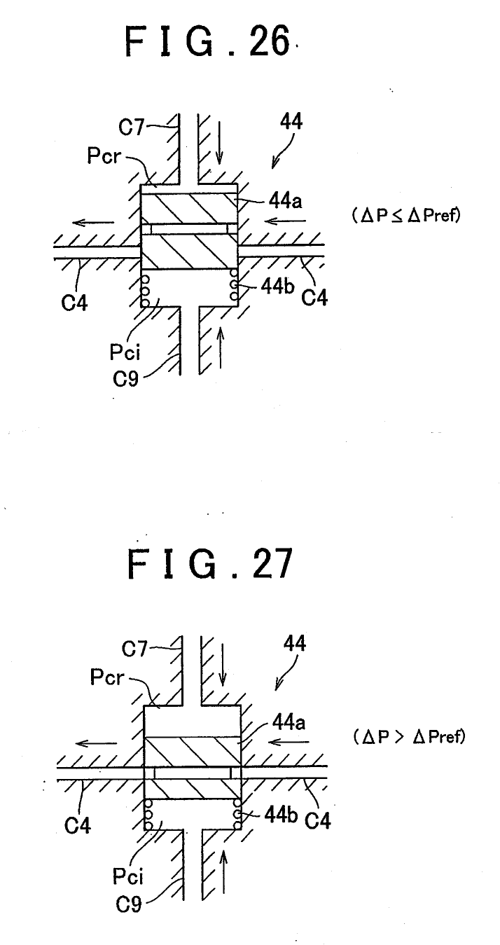

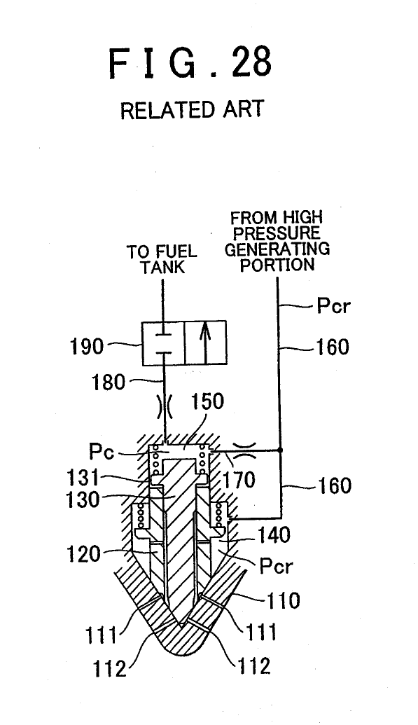

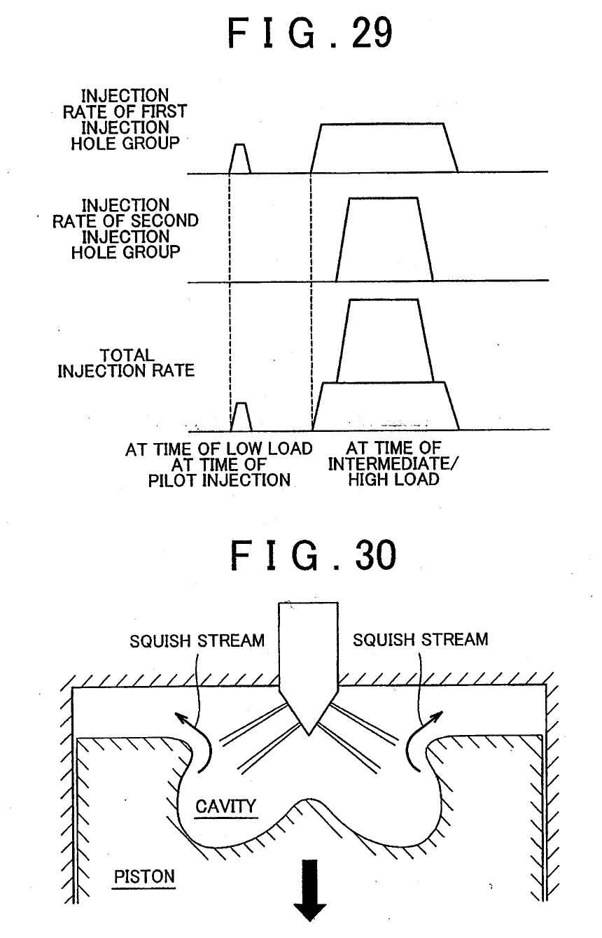

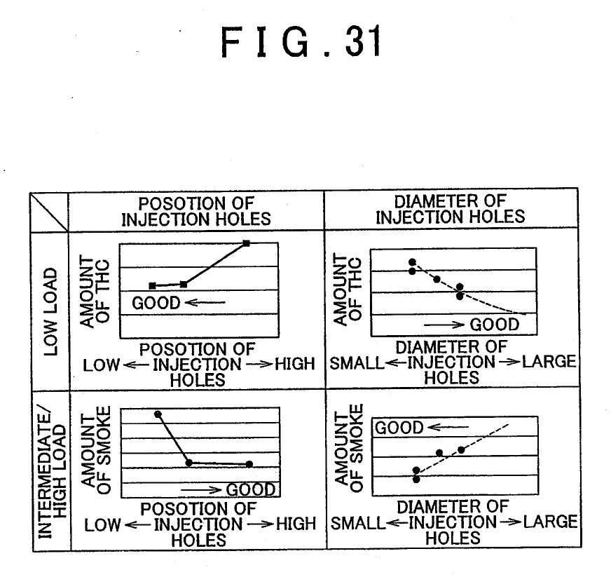

More specifically, as shown in FIG. 26, the automatic valve 44 of the second embodiment of the invention is different from the automatic valve 44 of the first embodiment of the invention only in that the lower face of the spool 44a receives the inner control pressure Pci supplied from the inner fuel outflow passage C5 via a flow passage C9 (see FIG. 5) and further receives a force acting downward (in the valve opening direction).

Thus, the spool 44a operates in accordance with the differential pressure ΔP (=Pcr−Pci). As a result, the automatic valve 44 shuts off the outer fuel outflow passage C4 (see FIG. 26) when the differential pressure ΔP is equal to or lower than a predetermined value ΔPref, and renders in communication the outer fuel outflow passage C4 (see FIG. 27) when the differential pressure ΔP is higher than the predetermined value ΔPref.

As described above, this automatic valve 44 is also constructed using the spool that operates upon receiving the pressure of fuel without the aid of an electric signal as in the case of the foregoing first embodiment of the invention. Therefore, the automatic valve 44 can be constructed in a much smaller size than the control valve 45 as the electromagnetic open/close valve.

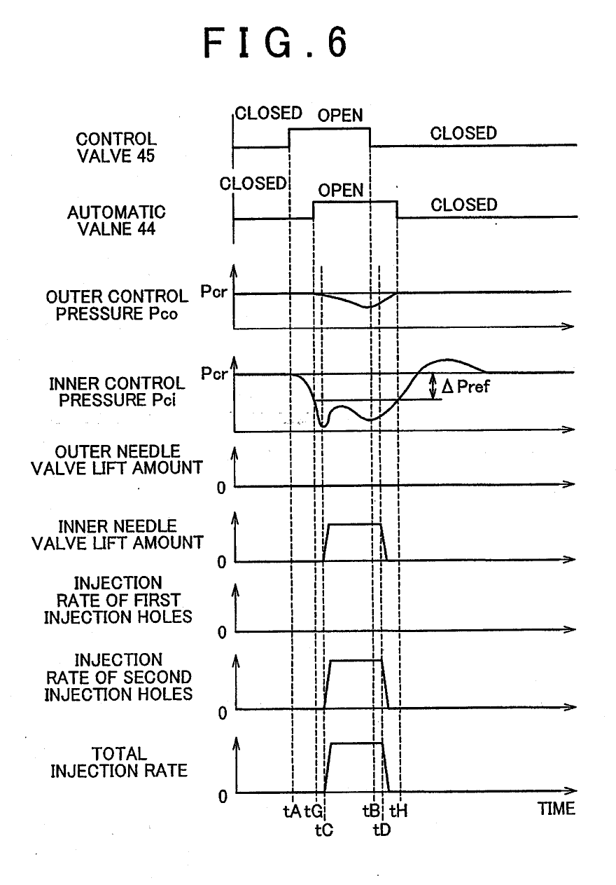

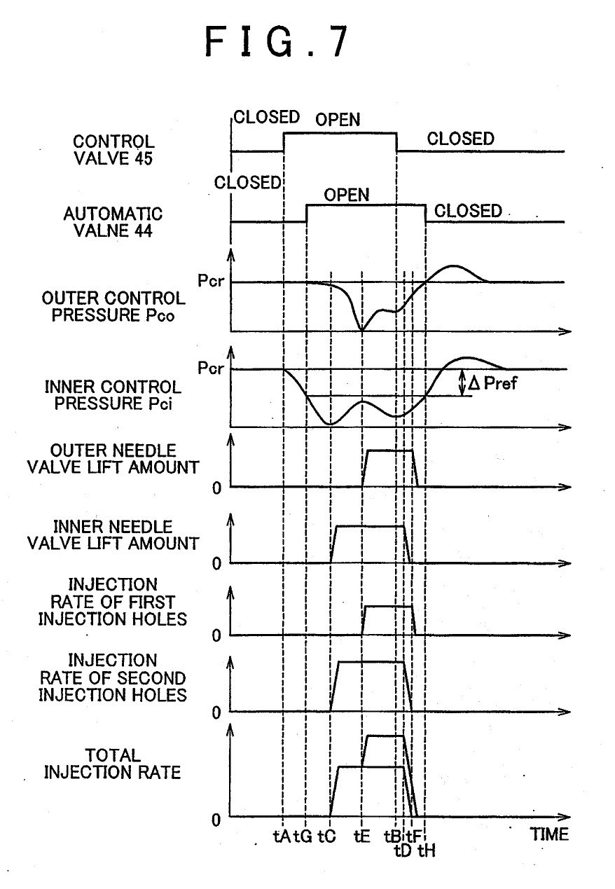

Next, an example of the operation of this second embodiment of the invention will be described with reference to FIGS. 6 and 7. First of all, FIG. 6 will be described.

Each solid line shown in FIG. 6 indicates an exemplary case where the control valve 45 is held in its open valve state between the time points tA and tB when the amount of injection is small, for example, at the time of pilot injection. In this second embodiment of the invention, the automatic valve 44 is in its open valve state only between time points tG and tH, namely, in a period when the inner control pressure Pci is equal to or lower than a pressure (Pcr-ΔPref).

That is, even when the control valve 45 opens at the time point tA, the outer control pressure Pco is held at the rail pressure Pcr until the time point tG when the inner control pressure Pci reaches the pressure (Pcr-ΔPref), and starts falling at the time point tG. That is, the timing when the outer control pressure Pco starts falling is retarded. Accordingly, in the case of a small injection amount (i.e., when the open valve period tA to tB of the control valve 45 is short), the control valve 45 closes in response to the advent of the time point tB before the outer control pressure Pco falls to “the valve opening pressure for the outer needle valve”, as shown in FIG. 6.

As a result, the outer needle valve 42 does not open. Accordingly, in the case of a small injection amount (e.g., at the time of pilot injection, low load, or the like), only the inner needle valve 43 can be opened (i.e., only the second injection holes 41b with the large diameter can be opened) as in the case of the foregoing first embodiment of the invention.

Next, FIG. 7 will be described. Each solid line shown in FIG. 7 indicates an exemplary case where the control valve 45 is held in its open valve state between the time points tA and tB when the amount of injection is large. In this case, unlike the case shown in FIG. 6, the open valve period tA to tB of the control valve 45 is long. Therefore, the outer control pressure Pco falls to “the valve opening pressure for the outer needle valve” and the outer needle valve 42 opens at the time point tE before the advent of the time point tB.

However, as described above, the timing when the outer control pressure Pco starts falling is retarded. Therefore, the time point tE as the timing for opening the outer needle valve 42 is also retarded. As a result, in the case of a large injection amount (in general, at the time of intermediate/high load), the inner needle valve and the outer needle valve open in this order as opposed to the case of the foregoing first embodiment of the invention. That is, the pattern of injection at the time of intermediate/high load can be set different from that of the foregoing first embodiment of the invention.

As described above, according to the second embodiment of the fuel injection control device of the invention, in the case of a small injection amount (e.g., at the time of pilot injection, low load, or the like), only the inner needle valve 43 can be opened as in the case of the foregoing first embodiment of the invention. Also, in the case of a large injection amount (in general, at the time of intermediate/high load), the pattern of injection can be set different from that of the foregoing first embodiment of the invention.

### Modification Example of Second Embodiment

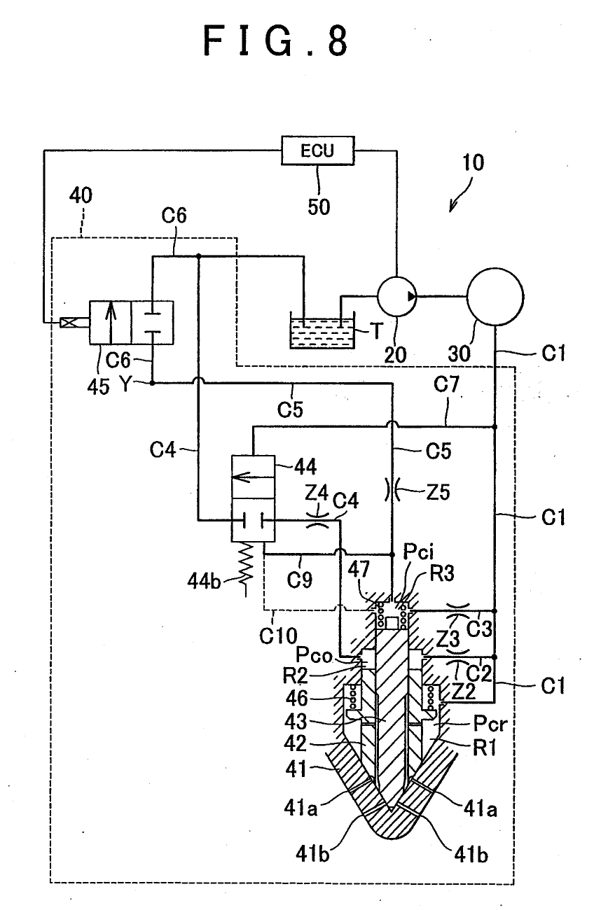

Next, the fuel injection control device 10 for the internal combustion engine according to a modification example of the second embodiment of the invention will be described. FIG. 8 shows a schematic construction of the entire device according to this modification example of the second embodiment of the invention. This modification example of the second embodiment of the invention is different from the foregoing second embodiment of the invention in which the downstream end of the outer fuel outflow passage C4 meets with the downstream end of the inner fuel outflow passage C5 at the meeting portion Y, only in that the outer fuel outflow passage C4 is connected at the downstream end thereof to the fuel discharge passage C6 at a position downstream of the control valve 45.

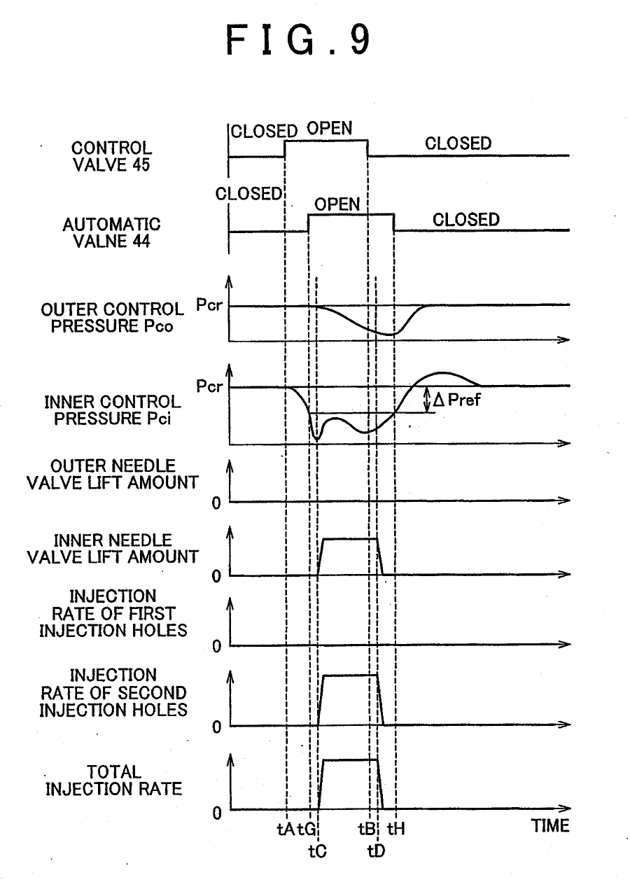

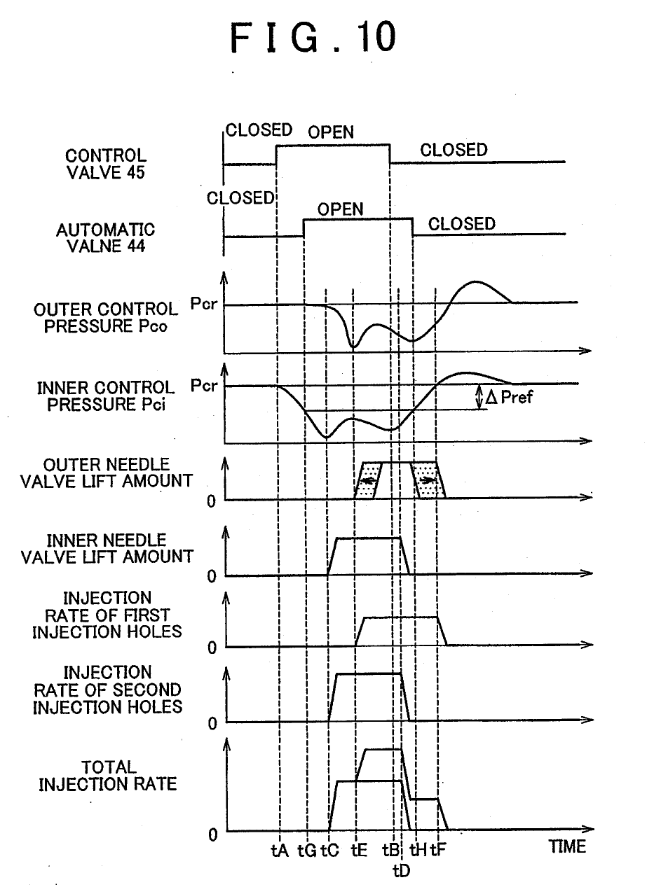

FIGS. 9 and 10 each show an example of the operation of this modification example of the second embodiment of the invention. FIGS. 9 and 10 correspond to FIGS. 6 and 7 respectively. FIG. 9 shows an example in which the amount of injection is small at the time of, for example, pilot injection. FIG. 10 shows an example in which the amount of injection is large.

In this modification example of the second embodiment of the invention, the differential pressure between regions upstream and downstream of the automatic valve 44 after the opening of the automatic valve 44 at the time point tG is higher by a value corresponding to the pressure loss in the control valve 45, in comparison with the foregoing second embodiment of the invention. Accordingly, the outer outflow orifice flow rate Qouto after the time point tG is higher than in the foregoing second embodiment of the invention. Therefore, the outer control pressure Pco- falls faster than in the foregoing second embodiment of the invention after the time point tG.

In addition, even when the control valve 45 closes at the time point tB, the outer control chamber R2 remains in communication with the fuel tank T until the automatic valve 44 thereafter closes at the time point tH. That is, the outer control pressure Pco starts rising toward the rail pressure Pcr at the time point tB in the foregoing second embodiment of the invention, but at the time point tH later than the time point tB in the modification example of the second embodiment of the invention.

FIG. 9 shows an example in which the automatic valve 45 closes in response to the advent of the time point tH before the outer control pressure Pco falls to “the valve opening pressure for the outer needle valve” although the outer control pressure Pco falls fast after the time point tG when the automatic valve 44 opens as a result of the short open valve period tA to tB of the control valve 45.

As a result, the outer needle valve 42 does not open. Accordingly, in the case of a small injection amount (e.g., at the time of pilot injection, low load, or the like), only the inner needle valve 43 can be opened (i.e., only the second injection holes 41b with the large diameter can be opened) as in the case of the foregoing second embodiment of the invention.

FIG. 10 shows an example in which the outer control pressure Pco falls to “the valve opening pressure for the outer needle valve” and the outer needle valve 42 opens at the time point tE before the advent of the time point tH as a result of the long open valve period tA to tB of the control valve 45.

It should be noted herein that, as described above, the outer control pressure Pco falls faster than in the foregoing second embodiment of the invention after the time point tG. Therefore, the time point tE when the outer control pressure Pco reaches “the valve opening pressure for the outer needle valve” (i.e., the timing when the outer needle valve lift amount starts increasing) is advanced in comparison with the foregoing second embodiment of the invention (see a left region indicated by fine dots in FIG. 10).

In addition, as described above, the timing when the outer control pressure Pco starts rising toward the rail pressure Pcr is retarded. Therefore, the time point tH as the timing when the outer needle valve lift amount starts decreasing is retarded in comparison with the foregoing second embodiment of the invention (see a right region indicated by fine dots in FIG. 10).

As is apparent from the foregoing description, in the case of a large injection amount (in general, at the time of intermediate/high load), the open valve period of the outer needle valve 42 is longer than in the foregoing second embodiment of the invention. Accordingly, the ratio of injection from the first injection holes 41a increases, and the discharge amount of smoke can further be reduced in comparison with the foregoing second embodiment of the invention.

In addition, the amount of injection from the first injection holes 41a can be made large especially in the latter half of the total fuel injection period. Therefore, the re-oxidization of the smoke once produced is promoted. As a result, owing to this effect as well, the discharge amount of smoke can be reduced.

As described above, according to the modification example of the second embodiment of the fuel injection control device of the invention, in the case of a large injection amount (in general, at the time of intermediate/high load), the ratio of injection from the first injection holes 41a is larger than in the foregoing second embodiment of the invention, and the amount of injection from the first injection holes 41a in the latter half of the total fuel injection period is larger than in the foregoing second embodiment of the invention. Therefore, the discharge amount of smoke can further be reduced.

### Third Embodiment

Next, the fuel injection control device 10 for the internal combustion engine according to the third embodiment of the invention will be described. FIG. 11 shows a schematic construction of the entire device according to this third embodiment of the invention. This third embodiment of the invention is different from the foregoing first embodiment of the invention in which the automatic valve 44 is designed as the single two-position, two-port type open/close valve, in that the automatic valve 44 is composed of two two-position, three-port type valves 44A and 44B.

The two two-position, three-port type valves 44A and 44B, which constitute the automatic valve 44 of this third embodiment of the invention, integrally operate in accordance with the rail pressure Pcr. This automatic valve 44 is connected to the downstream ends of the outer fuel outflow passage C4 and the inner fuel outflow passage C5 and the upstream ends of the first fuel outflow passage C11 and the second fuel outflow passage C12.

The first fuel outflow passage C11 and the second fuel outflow passage C12 are fitted with a first orifice Z11 and a second orifice Z12 respectively. The first orifice Z11 has a smaller throttle diameter than the second orifice. The single control valve 45 is interposed in the fuel discharge passage C6, which connects a meeting portion X of the downstream end sides of the first fuel outflow passage C11 and the second fuel outflow passage C12 to the fuel tank T.

This automatic valve 44 connects the outer fuel outflow passage C4 to the first fuel outflow passage C11 and the inner fuel outflow passage C5 to the second fuel outflow passage C12 (a first position shown in FIG. 11) when the rail pressure Pcr is equal to or lower than the first predetermined value Pcrref1 (at the time of low rail pressure), and connects the outer fuel outflow passage C4 to the second fuel outflow passage 12 and the inner fuel outflow passage C5 to the first fuel outflow passage C11 when the rail pressure Pcr is higher than the first predetermined value Pcrref1 (at the time of intermediate/high rail pressure) (a second position).

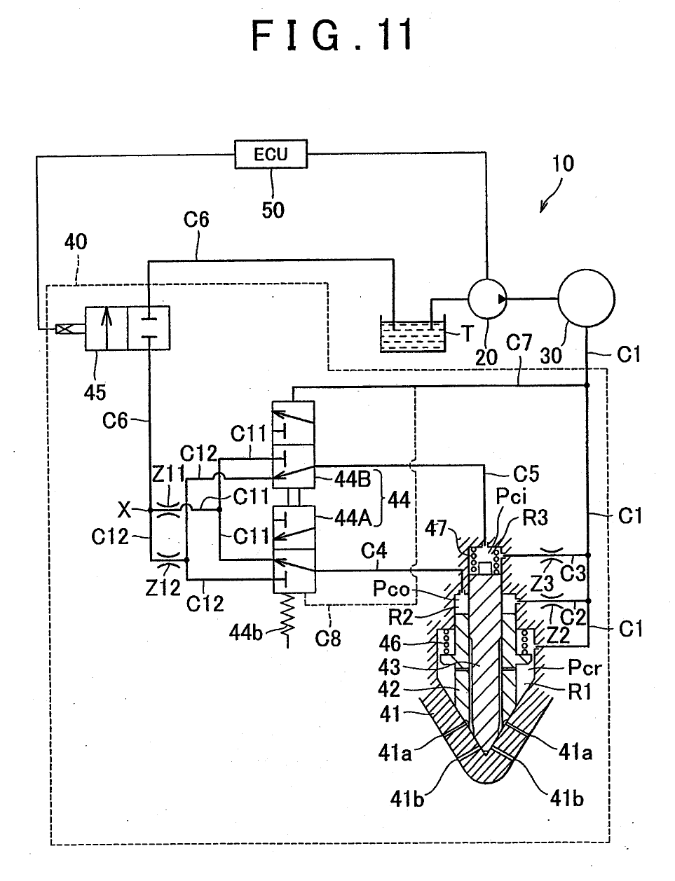

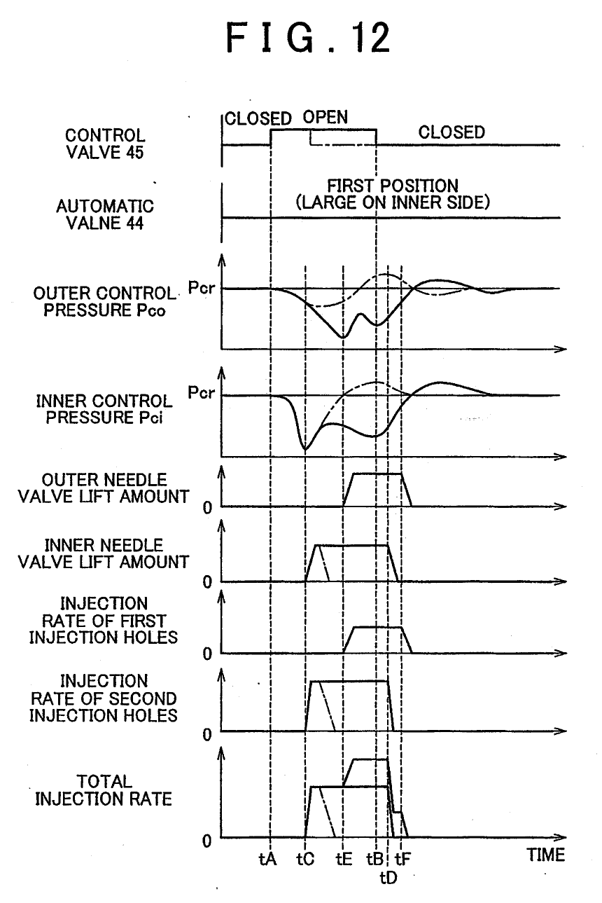

Each solid line of FIG. 12 shows an example of the operation of the third embodiment of the invention in the case where the control valve 45 is held in its open valve state between the time points tA and tB at the time of low rail pressure. At the time of low rail pressure, the automatic valve 44 is at the first position with the control valve 45 in its open valve state (between the time points tA and tB). Therefore, fuel in the outer control chamber R2 is discharged to the fuel tank T via the first orifice Z11 with the small throttle diameter, and fuel in the inner control chamber R3 is discharged to the fuel tank T via the second orifice Z12 with the large throttle diameter.

Accordingly, the inner control pressure Pci falls faster than the outer control pressure Pco. As a result, the time point tC when the inner control pressure Pci reaches “the valve opening pressure for the inner needle valve” is earlier than the time point tE when the outer control pressure Pco reaches “the valve opening pressure for the outer needle valve”. That is, the inner needle valve 43 and the outer needle valve 42 open in this order. Accordingly, as indicated by broken lines of FIG. 12, at the time of low rail pressure, pilot injection with the short open valve period of the control valve 45 is carried out from the second injection holes 41b. Thus, at the time of low rail pressure, namely, at the time of low load (in carrying out pilot injection at the time of low load as well), the diffusion of fuel sprays in the combustion chamber can be suppressed, and the discharge amount of THC can be reduced.

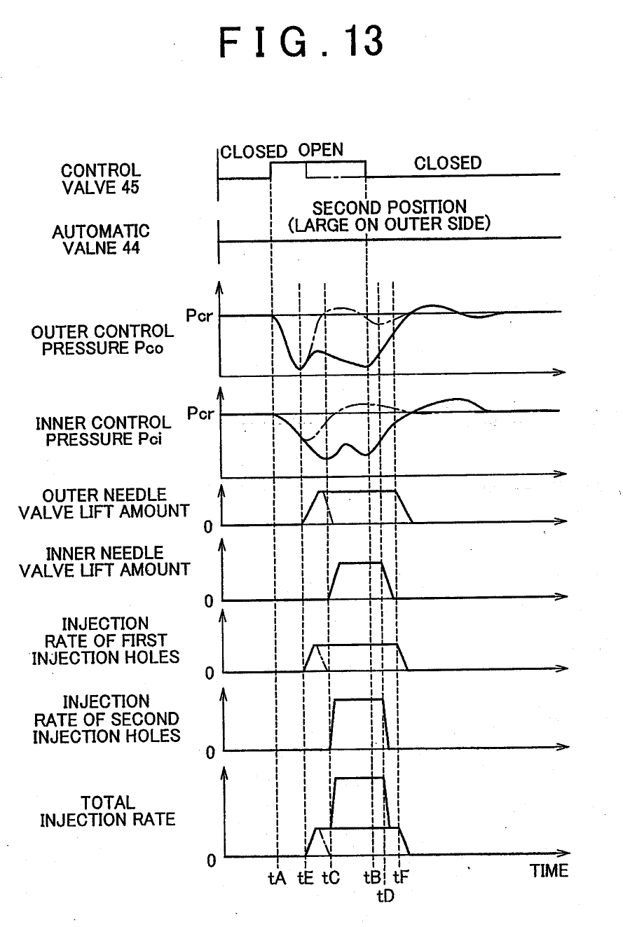

Each solid line of FIG. 13 indicates an example of the operation of the third embodiment of the invention in the case where the control valve 45 is held in its open valve state between the time points tA and tB at the time of intermediate/high rail pressure. At the time of intermediate/high rail pressure, the automatic valve 44 is at the second position with the control vale. 45 in its open valve state (between the time points tA and tB). Therefore, fuel in the outer control chamber R2 is discharged to the fuel tank T via the second orifice Z12 with the large throttle diameter, and fuel in the inner control chamber R3 is discharged to the fuel tank T via the second orifice Z12 with the large throttle diameter and the first orifice Z11 with the small throttle diameter.

Accordingly, the outer control pressure Pco falls faster than the inner control pressure Pci. As a result, the time point tE when the outer control pressure Pco reaches “the valve opening pressure for the outer needle valve” is earlier than the time point tC when the inner control pressure Pci reaches “the valve opening pressure for the inner needle valve”. That is, the outer needle valve 42 and the inner needle valve 43 open in this order. Accordingly, as indicated by broken lines of FIG. 13, at the time of intermediate/high rail pressure, pilot injection with the short open valve period of the control valve 45 is carried out from the first injection holes 41a. Thus, at the time of intermediate/high rail pressure, namely, at the time of intermediate/high load (in carrying out pilot injection at the time of intermediate/high load as well), the diffusion (i.e., atomization) of fuel sprays in the combustion chamber is promoted, and the discharge amount of smoke can be reduced.

As described above, according to the third embodiment of the fuel injection control device of the invention, the relationship in magnitude between the speeds at which the outer control pressure Pco and the inner control pressure Pci fall respectively can be changed over depending on whether the rail pressure is low or intermediate/high. As a result, at the time of low load (in carrying out pilot injection at the time of low load as well), main injection is carried out from the second injection holes 41b. Thus, the diffusion of fuel sprays in the combustion chamber can be suppressed, and the discharge amount of THC can be reduced. On the other hand, at the time of intermediate/high load (in carrying out pilot injection at the time of intermediate/high load as well), main injection is carried out from the first injection holes 41a. Thus, the diffusion (e.g., atomization) of fuel sprays in the combustion chamber is promoted, and the discharge amount of smoke can be reduced.

### Fourth Embodiment

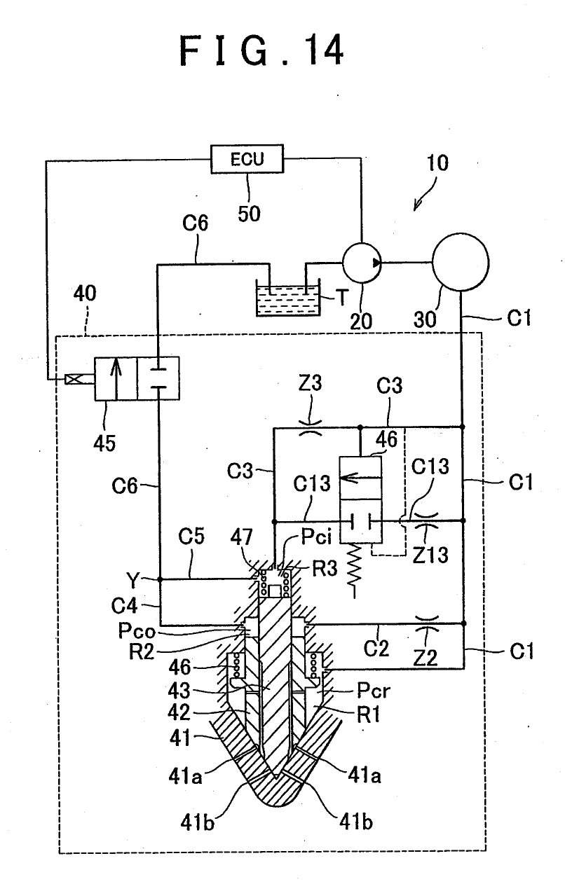

Next, the fuel injection control device 10 for the internal combustion engine according to the fourth embodiment of the invention will be described. FIG. 14 shows a schematic construction of the entire device according to this fourth embodiment of the invention. This fourth embodiment of the invention is different from the foregoing first embodiment of the invention in which the automatic valve 44 is interposed in the outer fuel outflow passage C4, in that a second inner fuel inflow passage C13 fitted with an orifice Z13, which is different from the inner fuel inflow passage C3, is provided and an automatic valve 46 is interposed in this second inner fuel inflow passage C13.

This automatic valve 46 is identical in construction to the automatic valve 44 in the foregoing first embodiment of the invention. That is, the automatic valve 46 shuts off the second inner fuel inflow passage C13 when the rail pressure Pcr is equal to or lower than the first predetermined value Pcrref1 (at the time of low rail pressure), and renders in communication the second inner fuel inflow passage C13 when the rail pressure Pcr is higher than the first predetermined value Pcrref1 (at the time of intermediate/high rail pressure).

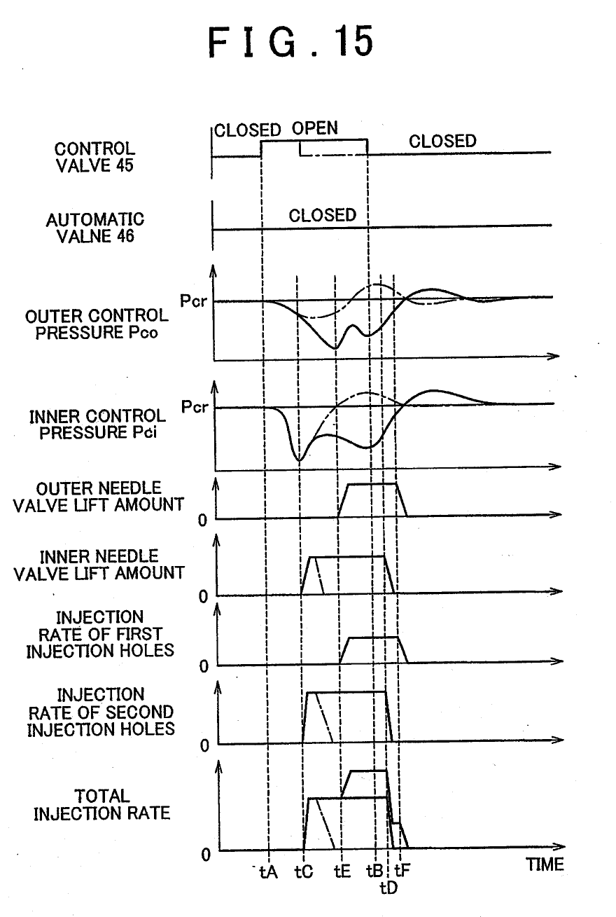

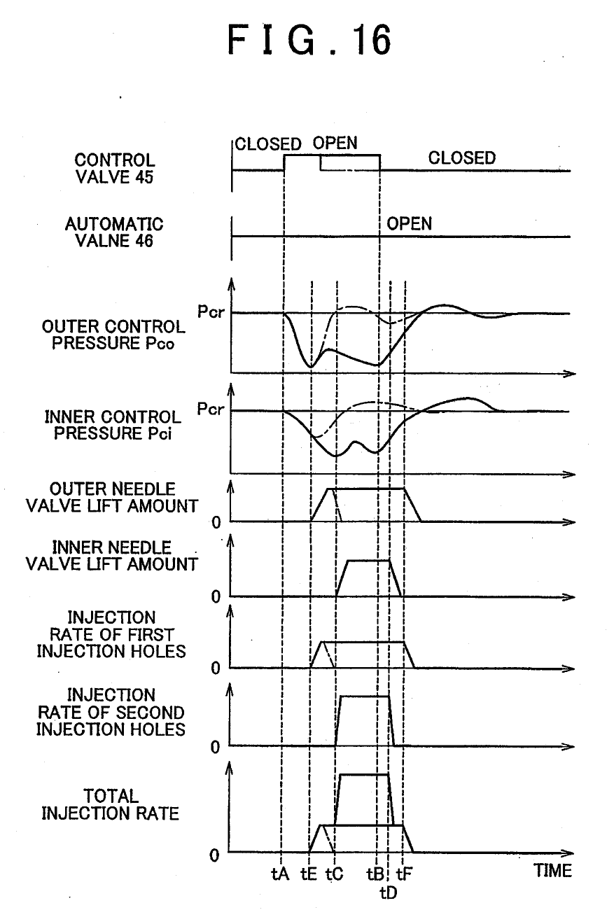

Each solid line of FIG. 15 indicates an example of the operation of the fourth embodiment of the invention in the case where the control valve 45 is held in its open valve state between the time-points tA and tB at the time of low rail pressure. Each solid line of FIG. 16 indicates an example of the operation of the fourth embodiment of the invention in the case where the control valve 45 is held in its open valve state between the time points tA and tB at the time of intermediate/high rail pressure.

At the time of low rail pressure, the automatic valve 46 is held in its closed state with the control valve 45 in its open valve state (between the time points tA and tB). Therefore, fuel flows from the fuel supply passage C1 into the inner control chamber R3 only via the inner fuel inflow passage C3. At the time of intermediate/high rail pressure, fuel flows from the fuel supply passage C1 into the inner control chamber R3 via the inner fuel inflow passage C3 and the second inner fuel inflow passage C13. On the other hand, fuel flows from the fuel supply passage C1 into the outer control chamber R2 only via the outer fuel inflow passage C2 without depending on the rail pressure Pcr.

Accordingly, as shown in FIG. 15, at the time of low rail pressure, the inner control pressure Pci can be made to fall faster than the outer control pressure Pco. As a result, as in the case of the foregoing third embodiment of the invention, the inner needle valve 43 and the outer needle valve 42 open in this order. Accordingly, as indicated by broken lines of FIG. 15, at the time of low rail pressure, pilot injection with the short open valve period of the control valve 45 is carried out from the second injection holes 41b. Thus, at the time of low rail pressure, namely, at the time of low load (in carrying out pilot injection at the time of low load as well), the diffusion of fuel sprays in the combustion chamber can be suppressed, and the discharge amount of THC can be reduced.

On the other hand, as shown in FIG. 16, at the time of intermediate/high rail pressure, the automatic valve 46 is held in its open state with the control valve 45 in its open valve state (between the time points tA and tB). Therefore, the outer control pressure Pco can be made to fall faster than the inner control pressure Pci. As a result, as in the case of the foregoing third embodiment of the invention, the outer needle valve 42 and the inner needle valve 43 open in this order. Accordingly, as indicated by broken lines of FIG. 16, at the time of intermediate/high rail pressure, pilot injection with the short open valve period of the control valve 45 is carried out from the first injection holes 41a. Thus, at the time of intermediate/high rail pressure, namely, at the time of intermediate/high load (in carrying out pilot injection at the time of intermediate/high load as well), the diffusion (i.e., atomization) of fuel sprays in the combustion chamber is promoted, and the discharge amount of smoke can be reduced.

As described above, according to the fourth embodiment of the fuel injection control device of the invention, as in the case of the foregoing third embodiment of the invention, the relationship in magnitude between the speeds at which the outer control pressure Pco and the inner control pressure Pci fall respectively can be changed over depending on whether the rail pressure is low or intermediate/high. Thus, an operation and an effect identical to those of the foregoing third embodiment of the invention are achieved.

### Modification Example of Fourth Embodiment

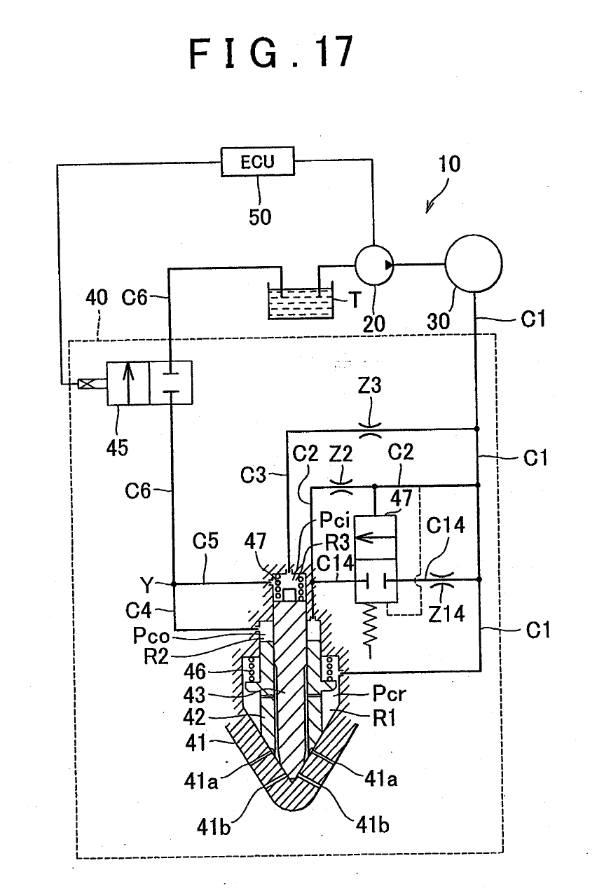

Next, the fuel injection control device 10 for the internal combustion engine according to a modification example of the fourth embodiment of the invention will be described. FIG. 17 shows a schematic construction of the entire device according to this modification example of the fourth embodiment of the invention. This modification example of the fourth embodiment of the invention is different from the foregoing first embodiment of the invention in which the automatic valve 44 is interposed in the outer fuel outflow passage C4, in that a second outer fuel inflow passage C14 fitted with an orifice Z14, which is different from the outer fuel inflow passage C2, is provided and an automatic valve 47 is interposed in this second outer fuel inflow passage C14.

This automatic valve 47 is also identical in construction to the automatic valve 44 in the foregoing first embodiment of the invention except that the automatic valve 47 opens/closes in the opposite direction. That is, the automatic valve 47 renders in communication the outer fuel inflow passage C14 when the rail pressure Pcr is equal to or lower than the first predetermined value Pcrref1 (at the time of low rail pressure), and shuts off the second outer fuel inflow passage C14 when the rail pressure Pcr is higher than the first predetermined value Pcrref1 (at the time of intermediate/high rail pressure).

In this modification example of the fourth embodiment of the invention, at the time of low rail pressure, the automatic valve 47 is held in its open state with the control valve 45 in its open valve state. Therefore, fuel flows from the fuel supply passage into the outer control chamber R2 via the outer fuel inflow passage C2 and the second outer fuel inflow passage C14. At the time of intermediate/high rail pressure, the automatic valve 47 is held in its closed state. Therefore, fuel flows from the fuel supply passage into the outer control chamber R2 only via the outer fuel inflow passage C2. On the other hand, fuel flows from the fuel supply passage C1 into the inner control chamber R3 only via the inner fuel inflow passage C3 without depending on the rail pressure Pcr.

Accordingly, as in the case of the foregoing fourth embodiment of the invention, the inner control pressure Pci can be made to fall faster than the outer control pressure Pco at the time of low rail pressure, and the outer control pressure Pco can be made to fall faster than the inner control pressure Pci at the time of intermediate/high rail pressure. Accordingly, an operation and an effect identical to those of the foregoing fourth embodiment of the invention can be achieved.

### Fifth Embodiment

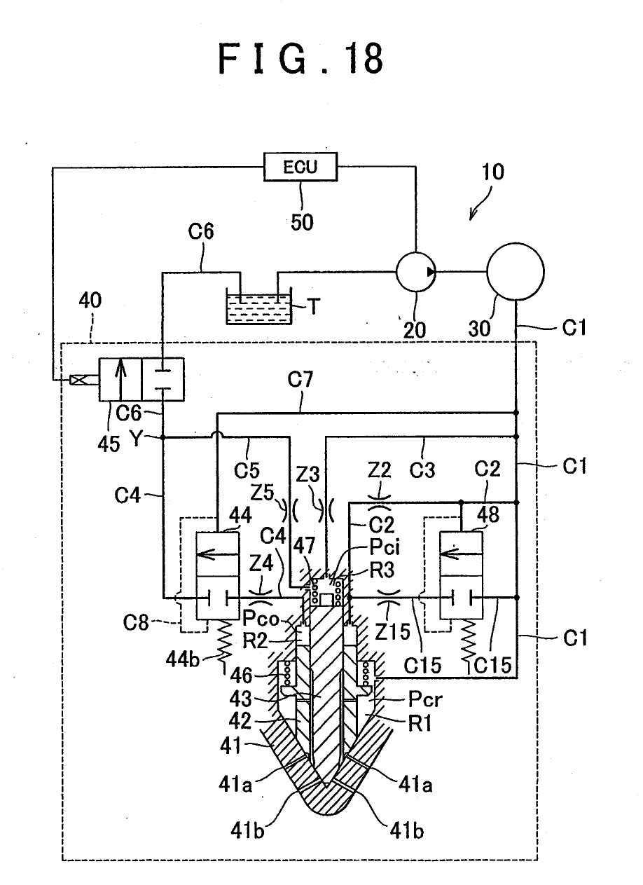

Next, the fuel injection control device 10 for the internal combustion engine according to the fifth embodiment of the invention will be described. FIG. 18 shows a schematic construction of the entire device according to this fifth embodiment of the invention. This fifth embodiment of the invention is different from the foregoing first embodiment of the invention in that a second outer fuel inflow passage C15 fitted with an orifice Z15, which is different from the outer fuel inflow passage C2, is provided and a second automatic valve 48 as well as the automatic valve 44 is interposed in this second outer fuel inflow passage C15.

This automatic valve 48 is identical in construction to the automatic valve 44 in the foregoing first embodiment of the invention except that the automatic valve 48 opens at a different pressure. That is, this second automatic valve 48 shuts off the second outer fuel inflow passage C15 when the rail pressure Pcr is equal to or lower than a second predetermined value Pcrref2 larger than the-first predetermined value Pcrref1 (at the time of low/intermediate rail pressure), and renders in communication the second outer fuel inflow passage C15 when the rail pressure Pcr is higher than the second predetermined value Pcrref2 (at the time of high rail pressure).

In this fifth embodiment of the invention, an operation and an effect different from those of the foregoing first embodiment of the invention are achieved only when the rail pressure Pcr is higher than the second predetermined value Pcrref2 (i.e., at the time of high rail pressure, hence at the time of high load).

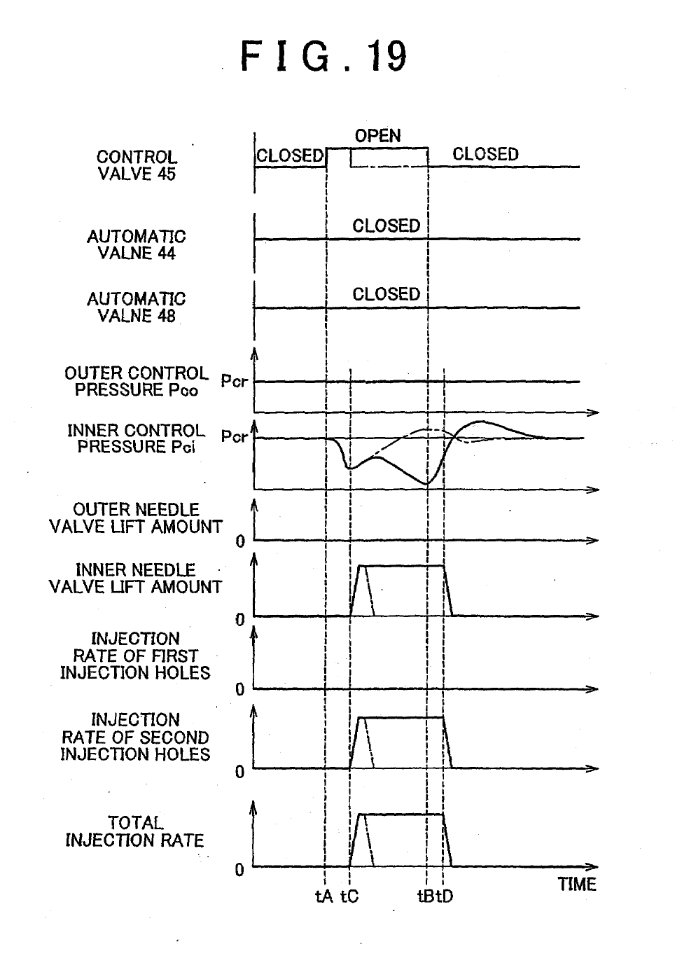

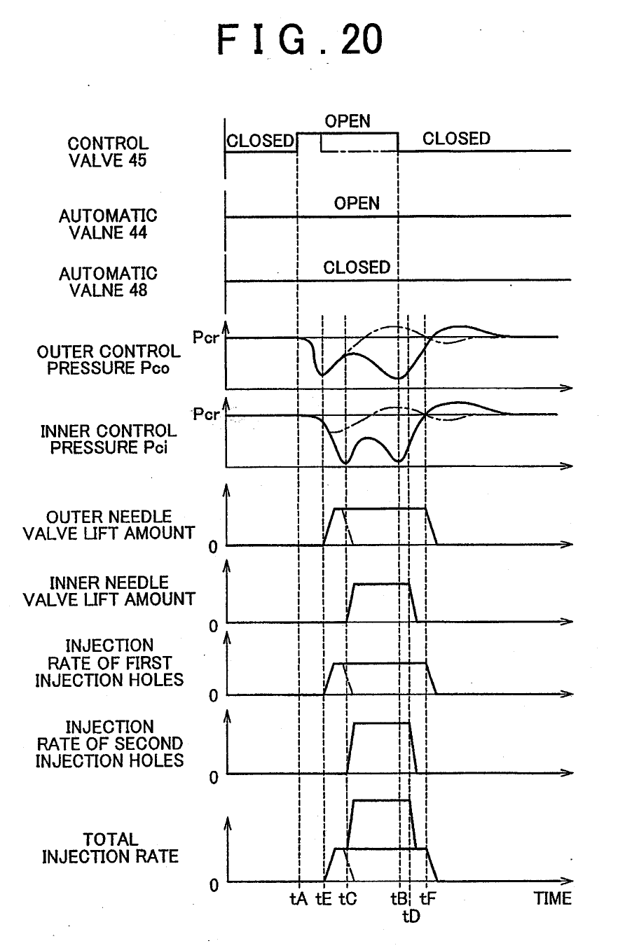

FIGS. 19 to 21 show examples of the operation of the fifth embodiment of the invention in the cases where the control valve 45 is held in its open valve state between the time points tA and tB at the time of low rail pressure, intermediate rail pressure (Pcrref1<Pcr<Pcrref2), and high rail pressure respectively. FIGS. 19 and 20 are identical to FIGS. 3 and 4, which correspond to the foregoing first embodiment of the invention, respectively except that a chart indicating that the automatic valve 48 is held in its closed state is added. Therefore, the description of FIGS. 19 and 20 will be omitted.

At the time of high rail pressure, fuel flows from the fuel supply passage into the outer control chamber R2 via the second outer fuel inflow passage C15 as well as the outer fuel inflow passage C2 in the open valve period tA to tB of the control valve 45 or after the closing of the control valve 45. That is, the outer control pressure Pco can be made to fall slower than in the foregoing first embodiment of the invention during the opening of the control valve 45, and to increase faster than in the foregoing first embodiment of the invention after the closing of the control valve 45.

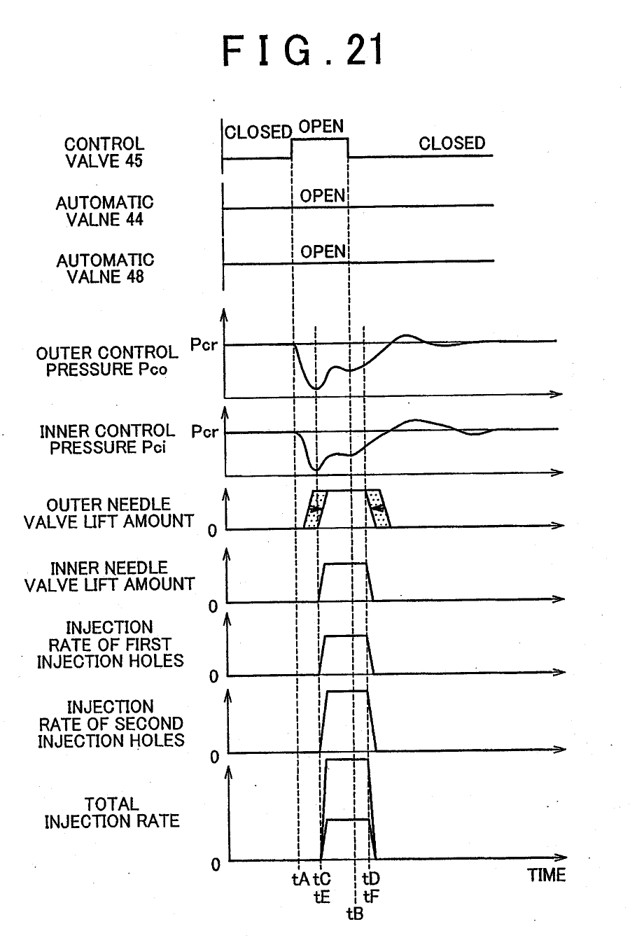

That is, as shown in FIG. 21, at the time of high rail pressure, the timing for opening the outer needle valve 42 (the timing when the outer needle valve lift amount starts increasing) can be retarded and the timing for closing the outer needle valve 42 (the timing when the outer needle valve lift amount starts decreasing) can be advanced in comparison with the foregoing first embodiment of the invention (see regions indicated by fine dots in FIG. 21).

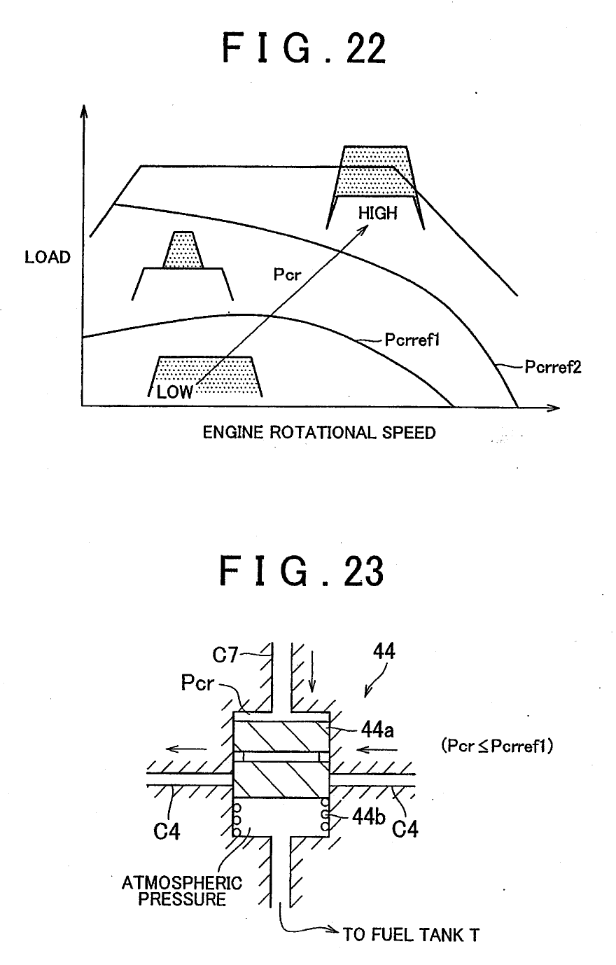

Accordingly, according to the fifth embodiment of the fuel injection control device of the invention, at the time of high rail pressure (hence at the time high load), the outer needle valve 42 and the inner needle valve 43 can be opened/closed substantially simultaneously (see the time points tC and tE and the time points td and tF). Thus, around the time of maximum load, a higher total injection rate can be ensured than in the foregoing first embodiment of the invention. As a result, the total period of fuel injection can be shortened. FIG. 22 is a graph showing how the pattern of fuel injection is related to load and engine rotational speed in this fifth embodiment of the invention. In FIG. 22, regions indicated by fine dots correspond to fuel injection from the second injection holes 41b.

The invention is not limited to the foregoing embodiments thereof, and various modification examples can be adopted within the scope of the invention. For example, the automatic valves 44 and 46 having the construction shown in FIGS. 23 and 24 are employed respectively in the foregoing first embodiment of the invention, the foregoing fourth embodiment of the invention, and the foregoing fifth embodiment of the invention. Instead of these automatic valves, however, an automatic valve having a construction shown in FIG. 25 may be adopted.

The automatic valve having the construction shown in FIG. 25 is different from the automatic valve 44 of the first embodiment of the invention only in that the lower face of the spool 44a receives, over a pressure-receiving area smaller than the pressure-receiving area for the rail pressure Pcr on the upper face of the spool 44a, the rail pressure Pcr supplied via a flow passage C8 (see FIGS. 1 and 18) and further receives a force acting downward (in the valve opening direction). Thus, the urging force of the coil spring 44b can be made small when the rail pressure Pcr is equal to the valve opening pressure of the automatic valve. Therefore, the coil spring 44b can be made small in size. Accordingly, the automatic valve can further be reduced in size.

In the foregoing second embodiment of the invention, the automatic valve 44 is designed to receive the inner control pressure Pci via the flow passage C9 (see FIGS. 5 and 8) connected to the inner fuel outflow passage C5. However, the automatic valve 44 may be designed to receive the inner control pressure Pci via a flow passage C10 (see FIGS. 5 and 8) directly connected to the inner control chamber R3.

In the foregoing first embodiment of the invention, the automatic valve 44 is interposed in the outer fuel outflow passage C4. However, the same automatic valve 44 may be interposed in the inner fuel outflow passage C5 instead of being interposed in the outer fuel outflow passage C4.

In each of the foregoing embodiments of the invention, the automatic valve may be interposed in at least one of the outer fuel inflow passage C2 and the inner fuel inflow passage C3 or at least one of the outer fuel outflow passage C4 and the inner fuel outflow passage C5.

In each of the foregoing embodiments of the invention, the automatic valve is constructed using the spool that operates upon receiving the pressure of fuel without the aid of an electric signal. However, the automatic valve may be constructed as a valve that employs an electromagnet, a piezoelectric element, or the like to be controlled with the aid of an electric signal.

1. A fuel injection control device comprising:
a body equipped at a tip portion thereof, which faces a combustion chamber of an internal combustion engine, with a first injection hole and a second injection hole located closer to a tip side of the body than the first injection hole;
a tubular outer needle valve slidably accommodated in the body to open/close the first injection hole on a tip side of the outer needle valve;
a rod-like inner needle valve slidably accommodated inside the outer needle valve to open/close the second injection hole on a tip side of the inner needle valve;
a nozzle chamber provided on the tip sides of the outer needle valve and the inner needle valve and designed such that each of the outer needle valve and the inner needle valve receives on the tip side thereof a force acting in a valve opening direction due to a rail pressure as a pressure of fuel inside the nozzle chamber and that fuel inside the nozzle chamber is injected toward the combustion chamber via the first injection hole and the second injection hole with the outer needle valve and the inner needle valve in open valve states thereof respectively;
an outer control chamber provided on a back side of the outer needle valve and designed such that the outer needle valve receives on the back side thereof a force acting in a valve closing direction due to an outer control pressure as a pressure of fuel inside the outer control chamber;
an inner control chamber provided on a back side of the inner needle valve and designed such that the inner needle valve receives on the back side thereof a force acting in a valve closing direction due to an inner control pressure as a pressure of fuel inside the inner control chamber, the inner control chamber being independent of the outer control chamber;
a high pressure generating portion (20, 30) for turning a pressure of fuel into the rail pressure;
a fuel supply passage connecting the high pressure generating portion to the nozzle chamber;
an outer fuel inflow passage connecting the fuel supply passage to the outer control chamber;
an inner fuel inflow passage connecting the fuel supply passage to the inner control chamber;
an outer fuel outflow passage connected at an upstream end thereof to the outer control chamber;
an inner fuel outflow passage connected at an upstream end thereof to the inner control chamber and meeting at a downstream end thereof with a downstream end of the outer fuel outflow passage;
a fuel discharge passage connecting a meeting portion of the outer fuel outflow passage and the inner fuel outflow passage to a fuel tank;
a control valve interposed in the fuel discharge passage to render in communication/shut off the fuel discharge passage; and
an automatic valve interposed in at least one of the outer fuel inflow passage and the inner fuel inflow passage or at least one of the outer fuel outflow passage and the inner fuel outflow passage to control flow of fuel in accordance with the rail pressure, wherein
the control valve is controlled to control the outer control pressure and the inner control pressure so that lift amounts of the outer needle valve and the inner needle valve are adjusted independently of each other in performing injection control of fuel.

2. The fuel injection control device according to claim 1, wherein the automatic valve is interposed in the outer fuel outflow passage to shut off the outer fuel outflow passage when the rail pressure is equal to or lower than a first predetermined value and render in communication the outer fuel outflow passage when the rail pressure is higher than the first predetermined value.

3. The fuel injection control device according to claim 1, wherein the automatic valve is interposed in the outer fuel outflow passage to shut off the outer fuel outflow passage when a differential pressure between the rail pressure and the inner control pressure is equal to or lower than a predetermined value and render in communication the outer fuel outflow passage when the differential pressure is higher than the predetermined value.

4. A fuel injection control device comprising:
a body equipped at a tip portion thereof, which faces a combustion chamber of an internal combustion engine, with a first injection hole and a second injection hole located closer to a tip side of the body than the first injection hole;
a tubular outer needle valve slidably accommodated in the body to open/close the first injection hole on a tip side of the outer needle valve;
a rod-like inner needle valve slidably accommodated inside the outer needle valve to open/close the second injection hole on a tip side of the inner needle valve;
a nozzle chamber provided on the tip sides of the outer needle valve and the inner needle valve and designed such that each of the outer needle valve and the inner needle valve receives on the tip side thereof a force acting in a valve opening direction due to a rail pressure as a pressure of fuel inside the nozzle chamber and that fuel inside the nozzle chamber is injected toward the combustion chamber via the first injection hole and the second injection hole with the outer needle valve and the inner needle valve in open valve states thereof respectively;
an outer control chamber provided on a back side of the outer needle valve and designed such that the outer needle valve receives on the back side thereof a force acting in a valve closing direction due to an outer control pressure as a pressure of fuel inside the outer control chamber;
an inner control chamber provided on a back side of the inner needle valve and designed such that the inner needle valve receives on the back side thereof a force acting in a valve closing direction due to an inner control pressure as a pressure of fuel inside the inner control chamber, the inner control chamber being independent of the outer control chamber;
a high pressure generating portion for turning a pressure of fuel into the rail pressure;
a fuel supply passage connecting the high pressure generating portion to the nozzle chamber;
an outer fuel inflow passage connecting the fuel supply passage to the outer control chamber;
an inner fuel inflow passage connecting the fuel supply passage to the inner control chamber;
an outer fuel outflow passage connected at an upstream end thereof to the outer control chamber;
an inner fuel outflow passage connected at an upstream end thereof to the inner control chamber;
a first fuel outflow passage fitted with a first orifice allowing passage of fuel flowing out from the outer fuel outflow passage or the inner fuel outflow passage;
a second fuel outflow passage fitted with a second orifice, which allows passage of fuel flowing out from the outer fuel outflow passage or the inner fuel outflow passage and has a throttle portion that is larger in opening area than a throttle portion of the first orifice, and meeting at a downstream end thereof with a downstream end of the first fuel outflow passage;
an automatic valve connected to downstream ends of the outer fuel outflow passage and the inner fuel outflow passage and upstream ends of the first fuel outflow passage and the second fuel outflow passage to connect the outer fuel outflow passage to the first fuel outflow passage and the inner fuel outflow passage to the second fuel outflow passage when the rail pressure is equal to or lower than a first predetermined value and connect the outer fuel outflow passage to the second fuel outflow passage and the inner fuel outflow passage to the first fuel outflow passage when the rail pressure is higher than the first predetermined value;
a fuel discharge passage connecting a meeting portion of the first fuel outflow passage and the second fuel outflow passage to a fuel tank; and
a control valve interposed in the fuel discharge passage to render in communication/shut off the fuel discharge passage, wherein
the control valve is controlled to control the outer control pressure and the inner control pressure so that lift amounts of the outer needle valve and the inner needle valve are adjusted independently of each other in performing injection control of fuel.

5. The fuel injection control device according to claim 1, wherein the inner fuel inflow passage has a first inner fuel inflow passage and a second inner fuel inflow passage, and
the automatic valve is interposed in the second inner fuel inflow passage to shut off the second inner fuel inflow passage when the rail pressure is equal to or lower than a first predetermined value and render in communication the second inner fuel inflow passage when the rail pressure is higher than the first predetermined value.

6. The fuel injection control device according to claim 1, wherein the outer fuel inflow passage has a first outer fuel inflow passage and a second outer fuel inflow passage, and
the automatic valve is interposed in the second outer fuel inflow passage to render in communication the second outer fuel inflow passage when the rail pressure is equal to or lower than a first predetermined value and shut off the second outer fuel inflow passage when the rail pressure is higher than the first predetermined value.

7. The fuel injection control device according to claim 2, further comprising:
a second outer fuel inflow passage connecting the fuel supply passage to the outer control chamber, the second outer fuel inflow passage being different from the outer fuel inflow passage; and
a second automatic valve interposed in the second outer fuel inflow passage to shut off the second outer fuel inflow passage when the rail pressure is equal to or lower than a second predetermined value larger than the first predetermined value and render in communication the second outer fuel inflow passage when the rail pressure is higher than the second predetermined value.

8. The fuel injection control device according to claim 2, wherein the automatic valve is equipped with a spool for rendering in communication/shutting off the outer fuel outflow passage, and is designed such that the spool receives on one end side thereof a force acting in a valve opening direction due to the rail pressure, receives on the other end side thereof a force acting in a valve closing direction due to an urging force of an elastic member, and operates in accordance with the rail pressure without an aid of an electric signal.

9. The fuel injection control device according to claim 3, wherein the automatic valve is equipped with a spool for rendering in communication/shutting off the outer fuel outflow passage, and is designed such that the spool receives on one end side thereof a force acting in a valve opening direction due to the rail pressure, receives on the other end side thereof a force acting in a valve closing direction due to the inner control pressure and an urging force of an elastic member, and operates in accordance with the differential pressure without an aid of an electric signal.

10. The fuel injection control device according to claim 4, wherein the automatic valve is equipped with a spool for making a changeover in a relationship about how the outer fuel outflow passage and the inner fuel outflow passage are connected to the first fuel outflow passage and the second fuel outflow passage, and is designed such that the spool receives on one end side thereof a force resulting from the rail pressure, receives on the other end side thereof an urging force of an elastic member, and operates in accordance with the rail pressure without an aid of an electric signal.

11. The fuel injection control device according to claim 5, wherein the automatic valve is equipped with a spool for rendering in communication/shutting off the second inner fuel inflow passage, and is designed such that the spool receives on one end side thereof a force acting in a valve opening direction due to the rail pressure, receives on the other end side thereof a force acting in a valve closing direction due to an urging force of an elastic member, and operates in accordance with the rail pressure without an aid of an electric signal.

12. The fuel injection control device according to claim 6, wherein the automatic valve is equipped with a spool for rendering in communication/shutting up the second outer fuel inflow passage, and is designed such that the spool (receives on one end side thereof a force acting in a valve closing direction due to the rail pressure, receives on the other end side thereof a force acting in a valve opening direction due to an urging force of an elastic member, and operates in accordance with the rail pressure without an aid of an electric signal.

13. The fuel injection control device according to claim 7, wherein the automatic valve is equipped with a spool for rendering in communication/shutting off the outer fuel outflow passage, and is designed such that the spool receives on one end side thereof a force acting in a valve opening direction due to the rail pressure, receives on the other end side thereof a force acting in a valve closing direction, and operates in accordance with the rail pressure without an aid of an electric signal, and
the second automatic valve is equipped with a second spool for rendering in communication/shutting off the second outer fuel inflow passage, and is designed such that the second spool receives on one end side thereof a force acting in a valve opening direction due to the rail pressure, receives on the other end side thereof a force acting in a valve closing direction due to an urging force of an elastic member, and operates in accordance with the rail pressure without an aid of an electric signal.

14. A method of controlling a fuel injection device, wherein the fuel injection device includes a body equipped at a tip portion thereof, which faces a combustion chamber of an internal combustion engine, with a first injection hole and a second injection hole located closer to a tip side of the body than the first injection hole, a tubular outer needle valve slidably accommodated in the body to open/close the first injection hole on a tip side of the outer needle valve, a rod-like inner needle valve slidably accommodated inside the outer needle valve to open/close the second injection hole on a tip side of the inner needle valve, a nozzle chamber provided on the tip sides of the outer needle valve and the inner needle valve and designed such that each of the outer needle valve and the inner needle valve receives on the tip side thereof a force acting in a valve opening direction due to a rail pressure as a pressure of fuel inside the nozzle chamber ) and that fuel inside the nozzle chamber is injected toward the combustion chamber via the first injection hole and the second injection hole with the outer needle valve and the inner needle valve in open valve states thereof respectively, an outer control chamber provided on a back side of the outer needle valve and designed such that the outer needle valve receives on the back side thereof a force acting in a valve closing direction due to an outer control pressure as a pressure of fuel inside the outer control chamber, an inner control chamber, which is independent of the outer control chamber, provided on a back side of the inner needle valve and designed such that the inner needle valve receives on the back side thereof a force acting in a valve closing direction due to an inner control pressure as a pressure of fuel inside the inner control chamber, a high pressure generating portion for turning a pressure of fuel into the rail pressure, a fuel supply passage connecting the high pressure generating portion to the nozzle chamber, an outer fuel inflow passage connecting the fuel supply passage to the outer control chamber, an inner fuel inflow passage connecting the fuel supply passage to the inner control chamber, an outer fuel outflow passage connected at an upstream end thereof to the outer control chamber, an inner fuel outflow passage connected at an upstream end thereof to the inner control chamber and meeting at a downstream end thereof with a downstream end of the outer fuel outflow passage, a fuel discharge passage connecting a meeting portion of the outer fuel outflow passage and the inner fuel outflow passage to a fuel tank, a control valve interposed in the fuel discharge passage to render in communication/shut off the fuel discharge passage, and an automatic valve interposed in at least one of the outer fuel inflow passage and the inner fuel inflow passage or at least one of the outer fuel outflow passage and the inner fuel outflow passage to control flow of fuel in accordance with the rail pressure, the method comprising:
controlling the control valve to control the outer control pressure and the inner control pressure so that lift amounts of the outer needle valve and the inner needle valve are adjusted independently of each other in performing injection control of fuel.
